(19) United States
(12) Patent Application Publication
(10) Pub. No.: US 2010/0272990 A1
(43) Pub. Date: Oct. 28, 2010

(54) EXTENSIBLE TRANSFER FILM FOR SURFACE COATING, PROCESS FOR PRODUCING IT, AND PROCESS FOR APPLYING IT

(75) Inventors: Valerio Bondesan, Garlasco (pv) (IT); Santo Caenazzo, Benaso (va) (IT)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: ALICE ENGINEERING di Bondesan Valerio e Caenazzo S, Garlasco (pv) (IT)

(21) Appl. No.: 12/161,458

(22) PCT Filed: Jan. 18, 2007
(86) PCT No.: PCT/EP2007/050476

§ 371 Date: Jul. 18, 2008

(30) Foreign Application Priority Data
Jan. 20, 2006 (IT) MI2006A000094

(51) Int. Cl. B32B 27/00; B29C 51/16; G02B 1/00; B32B 37/00; G02C 7/00; B44C 1/16

(52) U.S. Cl. 428/337; 156/230; 428/411.1; 428/412; 428/447; 428/474.4; 428/533; 428/480; 428/500; 428/332; 156/212

(57) ABSTRACT

Transferable and extensible film for coating of surfaces, even with high degree of concavity or convexity, to give them new properties like: abrasion resistance, color, hydrophobic property, anti reflection, or other interferential effects. The film has at 25° C. a maximum elongation higher than 70% and preferably higher than 100%. The film has preferably the configuration of an extensible transfer film assembly. The processes for producing the extensible film and the extensible transfer film assembly and applying them to a substrate are herein described.

### TECHNICAL FIELD

The present invention deals with an extensible transfer film for coating of substrates, preferably made of plastic, to confer their surfaces required properties. More specifically, the invention is suitable for substrates having surfaces at least partially not flat, and even more specifically with substrates having high degree of superficial concavity or convexity.

Typical examples for which the present invention can be applied are: lenses (particularly ophthalmic ones) and screens or displays for watches and cellular phones.

In the following description, it will be made specific reference to lenses for glasses as substrates for applying the extensible transfer film according to the invention; it is however to be understood that this reference does not limit the scope of the invention both for the type of the substrate to be coated and for the specific properties of the coating.

### BACKGROUND OF THE INVENTION

It is well known in the manufacturing industry of lenses, ophthalmic lenses, screen, displays and the like, that more and more frequently plastic material is used instead of glass for better processing and reduced weight.

The drawback of this approach is due to the reduced superficial resistance to scratches of the plastic materials resulting in a rapid wear out of the products.

It is also well known that in order to avoid this weakness, these plastic substrates are coated with a hard layer, typically 1 to 5 micron thick.

In addition, it is also known that layers, typically 0.001 to 0.2 micron thick, with different refractive index are also coated on the surfaces to reduce their reflection.

The most known technologies for the formation of said hard coating layers and said antireflection layers are: application of one or more layer of a hardening resin by dipping the substrate in the resin or by putting a drop of the resin in the center of the substrate surface and spreading it over by spinning the substrate—after the coating the resin is polymerized; vacuum deposition of hard oxides by evaporation or sputtering; plasma polymerization of organo-metallic precursors.

The most common of the above mentioned technologies are: dipping and spinning for hard coating and vacuum deposition for antireflection.

All these technologies have severe drawbacks which limit their application: those based on vacuum require costly and very sophisticated machinery and for these reasons can be used only in few specialized centers while those based on dipping and spinning offer limited thickness control of the coating (impairing mainly the antireflection), produce ecological impact, difficulty in matching the mechanical and optical characteristics of the substrate with the resin, and not negligible cost of the machinery.

Another limitation of the deposition technology by evaporation, which is the most common for the antireflection coatings, is the impossibility to obtain a uniform coating thickness on a curved surface: for geometric reasons the coating becomes thinner from center to the rim of the lens.

With this technology, the thickness of a deposited layer is proportional to the cosine of the angle formed by the direction of the deposition line and the normal to the plane tangent to the point of deposition. Practically even with angles of 30° to 40° strong variation of reflection color as well as reduced layer adhesion are evident.

From U.S. Pat. No. 6,319,594 and U.S. Pat. No. 6,489,015 the possibility of making multilayer films to apply to substrates is known as well. These films are substantially made of a layer of hard material for scratch protection on which one or more additional layers are added for anti reflection purpose. In addition, as for instance from USA patent application US 2004//0058177 and Japanese patent applications JP-A-2002-016462 and JP-A-2002-222900, the possibility of transferring films, including antireflection ones, from a temporary support to a final substrate is also known

Films obtained with these known technologies present however application limits because the hardness of these films is not compatible with the need of extensibility necessary for coupling with substrates having high curvature. The films are applicable only to flat surfaces or to surfaces with very limited curvature, where the elongation requested to the film is in the order of few percent. Also with the most traditional deposition technology the layers do not tolerate elongation of more than 1%-2% over which a failure takes place.

There is therefore a technical problem of producing a film of material having the required characteristics, hardness for instance, to coat the surface of a substrate, in particular made of plastic material, having a high curvature (ophthalmic lens or the like).

In addition, said film should have a uniform thickness and should be applicable with simple and reliable manner to produce precise and reproducible results on any surface, even curve, without the need of high temperature heating during the application which would not be compatible with the plastic material of the substrate.

The problem implies also that such film can be easily handled, stored, transported, and applied in spite of the reduced final thickness.

To be noted that a solution which is in compliance with some of the above requirements is described in the USA patent application US 2003/0017340, but such solution is very limited because it can be used only for a specific and predefined curvature and not for a large curvature range as for the present invention.

### SUMMARY OF THE INVENTION

These and other objectives are reached with the film according to the present invention, of the type including at least one layer to confer the surface of a substrate coated with the film required characteristic (e.g. transparency, color, scratch resistance, antireflection, hydrophobic property, etc.), wherein such layer is made of polymeric compound which is enough mechanical resistant but at the same time enough extensible and capable of being hardened after the application of the film to a substrate.

With reference to the above definition of the invention, said film, to simplify its handling and the transfer to the substrate, before the application to said substrate, can be part of an extensible transfer film assembly including said film and at least one removable support made of extensible material put in contact with said film (from now on called extensible support, being this support destined to be removed during the application of the film to the surface of the substrate to be coated) and optionally one or two external protective liners also removable during the application of the film to the surface of the substrate to be coated.

### BRIEF DESCRIPTION OF THE DRAWINGS

FIG. 1 represents the general and schematic cross section of the complete extensible transfer film assembly.

FIG. 2 describes the general principle of the production of the complete extensible transfer film assembly.

FIG. 3 describes the general principle of application of the film, in the case of a concave surface.

FIG. 4a-4m describes preferred embodiments of the extensible transfer film assembly for the following cases:
antiscratch transparent film (FIG. 4a)
antiscratch colored film (FIG. 4b)
transparent and hydrophobic film (FIG. 4c)
narrow band antireflection transparent film (FIG. 4d)
narrow band antireflection transparent and hydrophobic film (FIG. 4e)
narrow band antireflection and antiscratch transparent film (FIG. 4f)
narrow band antireflection, antiscratch and hydrophobic transparent film (FIG. 4g)
broad band antireflection transparent film (FIG. 4h)
broad band antireflection and hydrophobic transparent film (FIG. 4i)
broad band antireflection and antiscratch transparent film (FIG. 4l)
broad band antireflection, antiscratch and hydrophobic film (FIG. 4m)

FIGS. 5, 6 and 7 illustrate a preferred embodiment for the production of an extensible transfer film assembly with a two layer film, representing also the cases where the number of layers is one or more than 2.

FIGS. 8M, 9M, and 10M illustrate preferred embodiments of the application of the film on an ophthalmic substrate with concave and/or convex sides using a mechanical transfer system.

FIGS. 8P, 9P, and 10P illustrate preferred embodiments of the transfer of the film on an ophthalmic substrate with concave and/or convex sides using a pneumatic transfer system.

FIGS. 11a and 11b illustrate the reflectance characteristics of CR39 substrate coated with narrow or broad band antireflection film.

### DETAILED DESCRIPTION OF THE INVENTION

The invention is described in more details hereinafter by analyzing the structure of the extensible transfer film assembly along with the fundamental characteristics it must have in order to confer the coated substrate the required results, and eventually, some materials and approaches to be used for the practical production of said assembly and for applying the film to substrates with different type of curvature.

### Structure of the Extensible Transfer Film Assembly

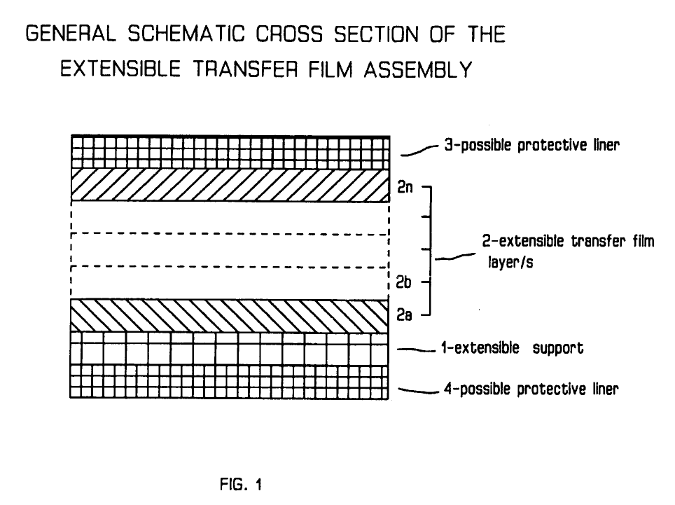

As mentioned before and schematically illustrated in the FIG. 1, the extensible transfer film assembly is made of the film (which can also have a multilayer structure), the extensible support, and the possible protective liners. In the following paragraphs the characteristics of all the components forming the extensible transfer film assembly will be deeply analyzed and the relevant functions will be described.

### Characteristics of the Components of the Extensible Transfer Film Assembly

### Extensible Transfer Film

### Generalities

The extensible transfer film is made of one or more layers suitable to confer the coated substrate requested properties, and is characterized by its extensibility and capability of being hardened after the application to a substrate.

The properties that said film, after its transfer to a substrate and its final hardening, confer the surface of the substrate are at least one of a set including the following ones: scratch resistance, color, hydrophobic property, antireflection or other interferential properties.

To be suitable for the majority of the substrates curvatures for which the invention has been conceived, (for instance ophthalmic lenses), its maximum elongation at 25° C. (that is the elongation before breaking or loss of optical properties) must be higher than 70% and preferably higher than 100% (before the final hardening).

It is important to clarify that in this document elongation is intended the percentage of the increase of the area of the film during its extension to fit the curvature of the substrate with respect to the area before the extension.

The values of the maximum elongation is correlated with those obtained with a specimen of the same material subjected to a uniaxial elongation; it is important to note that the first values are noticeably higher than the second ones by an amount depending on the specific material.

The extensible transfer film must also resist all the stresses arising in the various steps from its production to the final hardening after the application to a substrate.

It is worth noting that the stresses can be both compressive, (e.g. during the transfer when the film is compressed against the substrate to fit its surface shape), and tensile, (e.g. when the film before its final hardening is transferred from the temporary low adhesion support 5 to the extensible support 1, or when this extensible support is removed from the film after its application to the substrate S). Other stresses can arise during the production of the layers forming the film, due to possible different surface tensions between the individual layer and the support on which it is formed: after the evaporation of the solvent the layer must maintains its dimensions even in presence of possible stresses in this interface.

Next the characteristics of each layer forming the monolayer or multilayer film will be analyzed.

### Antiscratch Transparent Layer

This layer, due to its intrinsic hardness and relatively high thickness, confers the coated surface higher and sufficient resistance to superficial abrasion produced by rubbing with small and hard particles, and also to scratches that can be produced by larger and hard objects capable of penetrating the hard layer and the softer substrate underneath.

The anti scratch layer can be applied to the substrate either directly or, when necessary, with the interposition of a thin adhesion layer.

The thickness of the anti scratch layer ranges typically between 0.5 and 50 micron, and preferably between 2 and 10 micron; its scratch resistance is measured by the “Steel Wool Test” ratio (at least 2 and preferably higher than 5) and the “Bayer Test” ratio (at least 1 and preferably higher than 3). Test procedures are described in the example chapter.

### Hydrophobic Transparent Layer

Hydrophobic property is achieved when the material of the layer has low surface tension, which gives rise to a high contact angle of a water drop put on the layer.

The difficulty of water and other liquids to wet the surface of this layer, and therefore to adhere on it, produces an appreciable anti smear effect and helps maintaining the glasses clean, which is the reason for the market interest for this property (specially in presence of antireflection coating).

For the case of a water drop, the contact angle should be over 90° and preferably over 100°.

### Low Refraction Index Transparent Layer

In order that a single layer can produce antireflection effects, its refraction index should be lower than that of the substrate or the antiscratch layer on which it is applied, and preferably not higher than 1.5. Higher values are however accepted when high index substrates are used and/or when the antireflection property is obtained with a multilayer approach.

When this layer is in direct contact with the extensible support, and it is not hardened before the removal of this support (e.g. to avoid an increase of adhesion with it), it must have enough internal cohesion to avoid internal failures during the removal of said support.

The thickness of this type of layer is related to the light wavelength in the visible spectrum and also to the interferential effect to be obtained; it ranges typically from 0.005 to 0.1 micron and preferably from 0.02 to 0.1 micron.

### Medium or High Index Transparent Layer

Medium refraction index values ranges from 1.5 to 1.9 and preferably from 1.6 to 1.8.

High refraction index values ranges from 1.9 to 2.7 and preferably from 2.1 to 2.7.

The alternation of high or medium and low index layers produces the so called interferential effects that will be described later in more details.

Also in this case the thickness of this type of layer is related to the light wavelength in the visible spectrum and also to the interferential effect to be obtained; it ranges typically from 0.001 to 0.3 micron and preferably from 0.005 to 0.2 micron.

### Adhesion Transparent Layer (Between the Film and the Substrate or Between the Adjoining Layers of the Film)

When necessary between the adjoining layers of the film or between the film and the substrate, a thin layer of material can be inserted to enhance adhesion before and/or after the final hardening; these additional layers should behave like the normal layers of the film as far as extensibility and hardening are concerned.

The possible adhesion layers between the film layers would be part of the film, while the possible adhesion layer between the film and the substrate (primer layer) could be either part of the film or be formed on the substrate during the transfer phase (for instance by spreading the adhesion material all over its surface through a drop of the adhesion material put in the center of the substrate and pressed during the transfer phase, or by spreading the adhesive material directly on the substrate before the transfer).

The thickness of the adhesion layers between the film layers may range from 0.005 to 0.1 micron and that of the primer layer between the film and the substrate from 0.001 to 20 micron and preferably from 0.1 to 10 micron.

### Colored Layer

For coloring it is intended the effect produced by the selective absorption of some frequencies of the visible light in a medium while passing through it; the energy of the absorbed light is converted into heat and the color of the transmitted light is complementary to that of the absorbed light.

The effect is due to the absorption of some frequencies by some coloring materials (dye) dissolved in the medium, and/or by the light diffusion caused by small colored particles (pigments) dispersed in the medium.

### Other Layers

Besides the layers previously described, the invention can include also others with different characteristics like: conductive layer (with antistatic property), hydrophilic (anti dimming) layer, polarizing layer (as polarizing filter of the transmitted light), photosensitive layer (for photo chromatic effects), high toughness layer (to enhance impact resistance), etc.

### Multifunctional Layers

It is also possible and in some cases convenient to combine more characteristics in a single layer, for instance: color and scratch resistance, or high/medium/low index and color, or low index and hydrophobic property, or low index and adhesion, or medium/high index and conductivity etc.

### Multilayer Film

Combining the previously described layers it is possible to obtain various types of multilayer films to confer the coated substrate the requested properties.

The amount of combinations could be very high, but in practice it is reduced due to the following limitations:
(a) The possible adhesion layer between the film and the substrate can be used only as first layer (counting from the substrate on).
(b) The antiscratch layer can be used only as a first layer (counting from the substrate on) with the exception of the possible interposition between the substrate and the anti scratch layer of the adhesion layer (when necessary).
(c) The hydrophobic layer can be used only as last layer (counting from the substrate on).

Considering now multilayer films of the present invention with interferential effects (which include also the case of antireflection), they give a substrate coated with them particular optical properties depending on the thickness and refraction index of each layer.

In particular the multilayer antireflection film can have one or more layers according to the following preferred implementation approaches (other approaches are also possible):

the antireflection film has only one layer with low refraction index;
the antireflection film is comprising one medium or high refraction index layer followed by a low index one;
same structure of previous point (2) repeated more times;
the antireflection film comprises a sequence of medium high and low refraction index layer.

It is well known in the industry that the antireflection coating will produce a narrow or broad band reflectance reduction depending on the number of layers, their thickness and refraction indexes.

To be noted that the present invention, besides antireflection, can provide other interferential film types such as: mirror coatings, dichroic filters, band pass filters, etc.

### Extensible Support

The film can be part of an extensible transfer film assembly comprising the film itself, at least one removable support made of extensible material in contact with the film, said extensible support being destined to be removed during the transfer of the film to the substrate surface to be coated, and optionally one or two external protective liners which must be removed during the transfer phase.

The extensible support must have at least the same extensibility properties of the film because it also must adapt itself to the curvature of the substrate during the transfer. Therefore its maximum elongation at 25° C. should be higher than 70% and preferably higher than 100%.

This support, to comply with optical quality surfaces, must have very smooth surface (optical grade) and possibly, to widen the application and final hardening methods, it should have a good optical transmission and a good resistance to solvents.

The thickness of this support should be neither too low to avoid problems during the layer formation nor too high to avoid problems during the transfer; its thickness should range from 10 to 5000 micron and preferably from 30 to 1000 micron.

### Protective Liners

These liners must be easily removable without modifying the structure of the film. Their thickness can range from 10 to 500 micron and preferably from 30 to 100 micron.

### Preferred Embodiments

FIG. 4a-4m describes preferred embodiments of the extensible transfer film assembly for the following cases:
antiscratch transparent film (FIG. 4a)
antiscratch colored film (FIG. 4b)
transparent and hydrophobic film (FIG. 4c)
narrow band antireflection transparent film (FIG. 4d)
narrow band antireflection transparent and hydrophobic film (FIG. 4e)
narrow band antireflection and antiscratch transparent film (FIG. 4f)
narrow band antireflection, antiscratch and hydrophobic transparent film (FIG. 4g)
broad band antireflection transparent film (FIG. 4h)
broad band antireflection and hydrophobic transparent film (FIG. 4i)
broad band antireflection and antiscratch transparent film (FIG. 4l)
broad band antireflection, antiscratch and transparent film (FIG. 4m)

### Process for Producing the Extensible Transfer Film Assembly

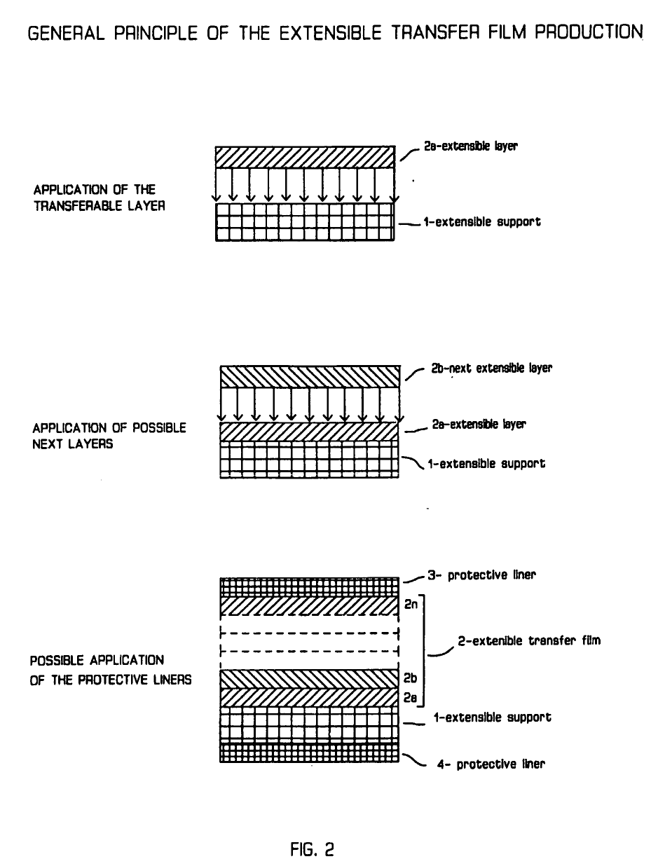

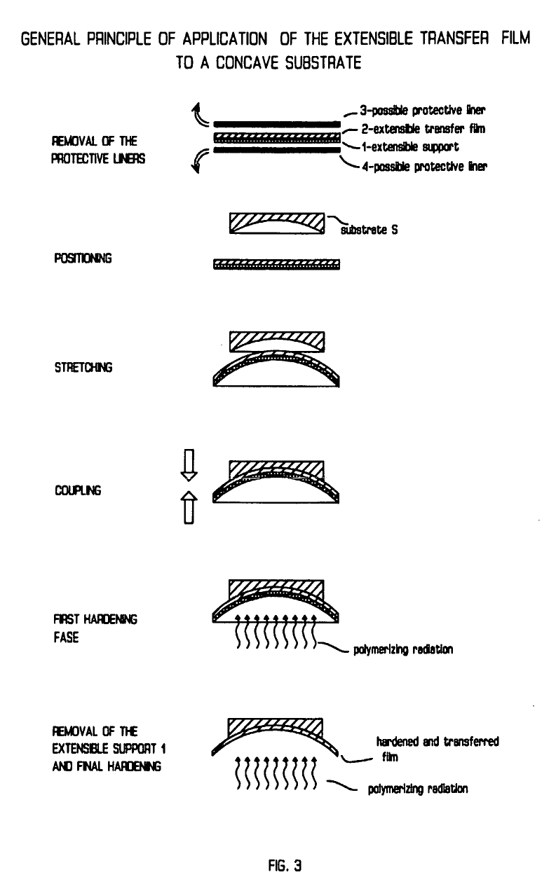

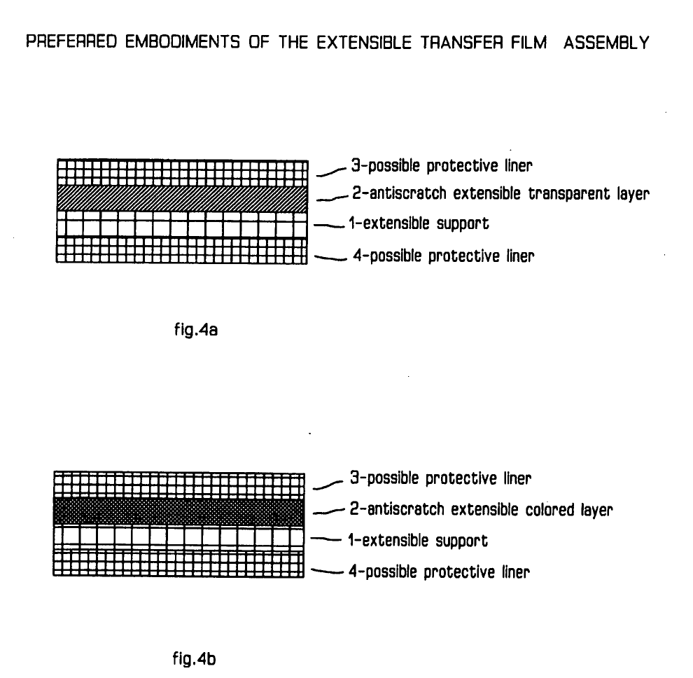

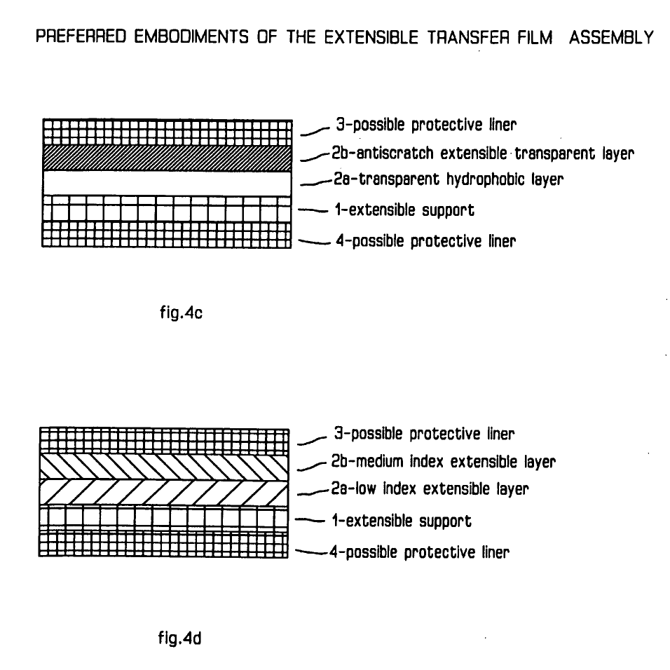

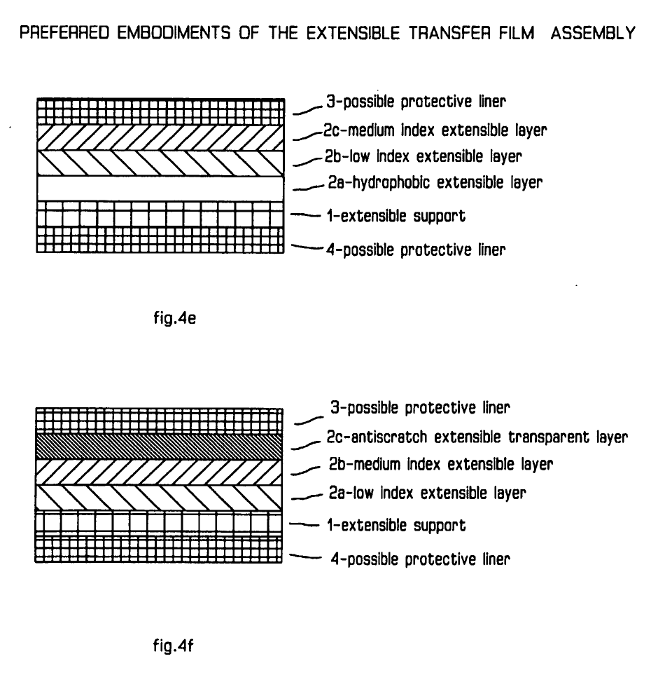

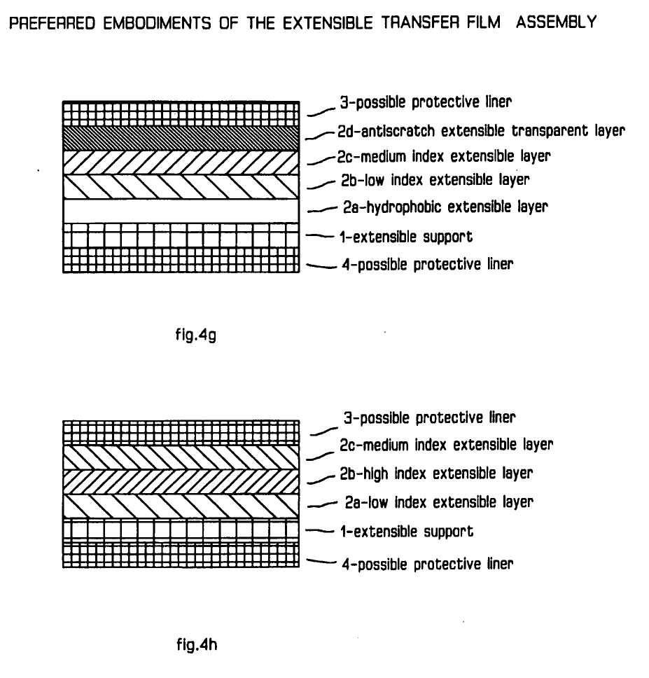

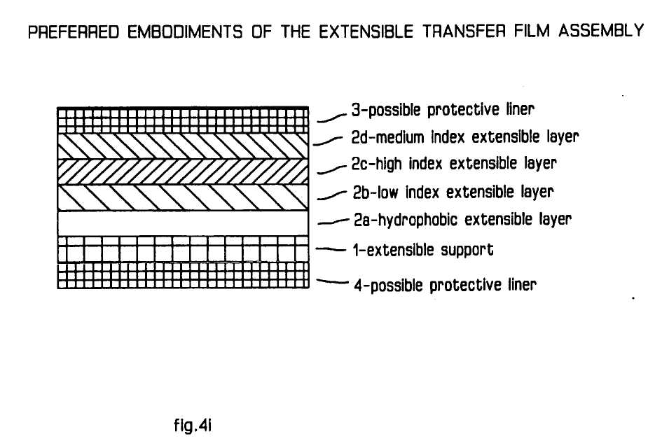

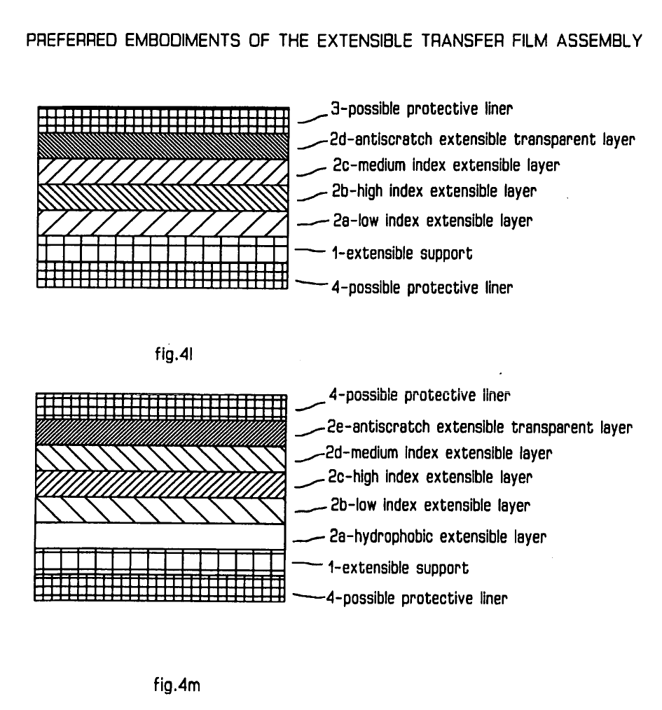

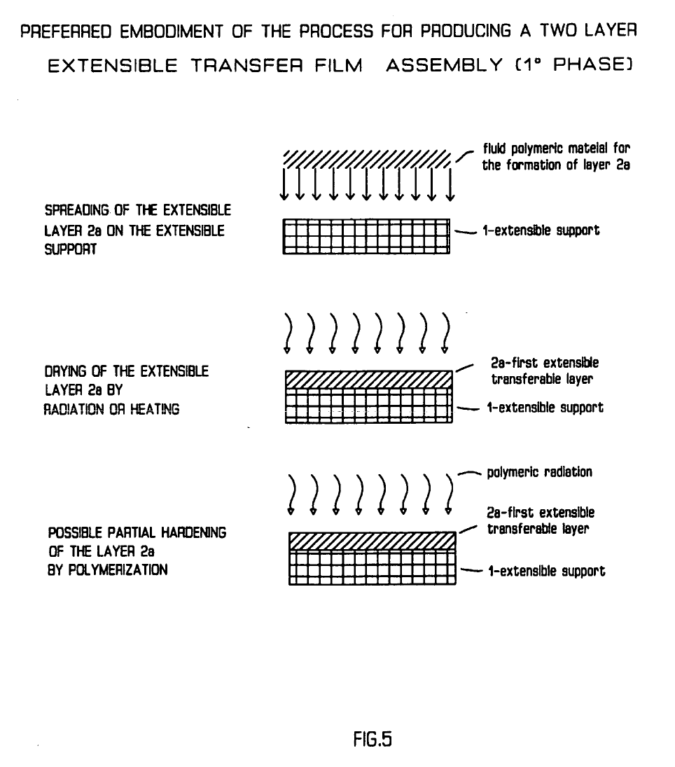

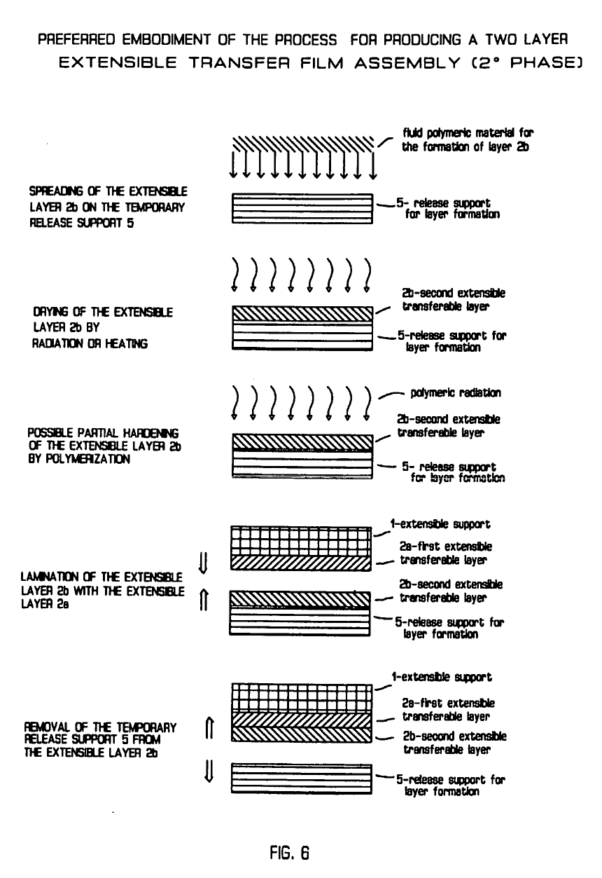

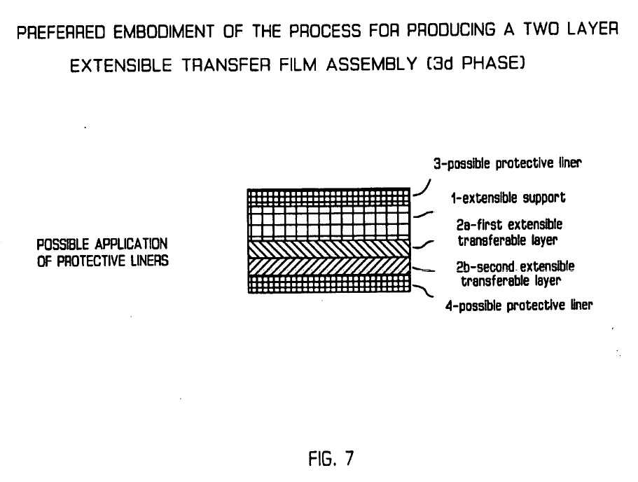

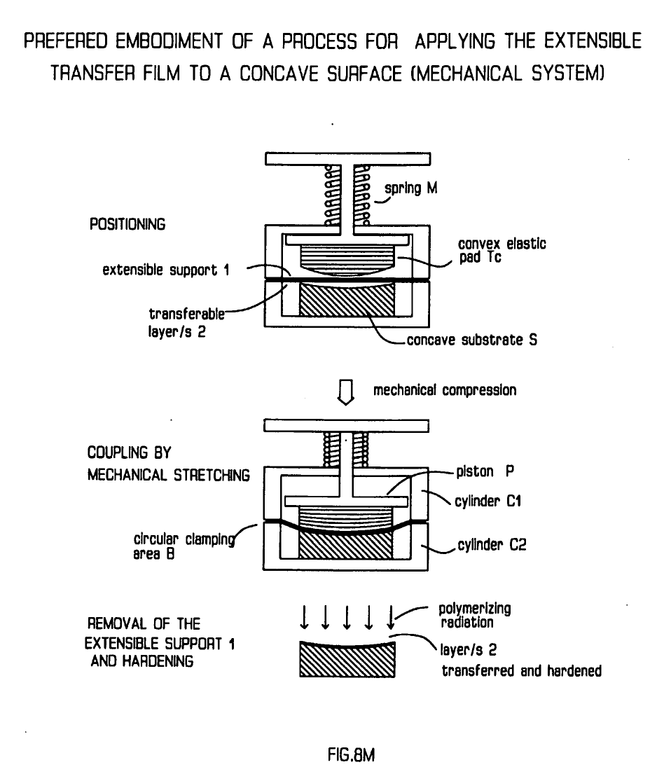

FIG. 2 describes the general principle for producing the complete extensible transfer film assembly according to the following sequence:
(a) Application to a surface of the extensible support 1 (possibly with the protective liner on the other side) of a layer 2 made of polymeric composition extensible and partially hardened;
(b) Possible superimposition on the first layer 2 of other layers of the same type 2 necessary to obtain the requested properties;
(c) Possible application of the liners 3 and/or 4.

In the following paragraphs, the materials and the approaches for the formation of the layers and the extensible transfer film assembly will be analyzed in detail.

### Techniques Used

### Single Layer Film

In the simplest approach the layer forming mixture is deposited directly on the extensible support through a variety of conventional means like: roll, gravure, micro-gravure, metering rod (Meyer rod) extrusion (curtain or slot die technology, to deposit more layers at the same time when possible) and other methods depending on the characteristics of the specific mixture to be deposited and on the thickness and thickness uniformity requested for the dry layer.

Once the layer is formed with the above mentioned methods, and when necessary, it can be partially hardened with any conventional method used for resins hardening, such as heating in oven, or irradiation with infrared, or UV and/or visible light, or electron beam. For example, in the case of UV and/or visible light irradiation, sources like high medium or low pressure mercury lamps, carbon or xenon arc, metallic halogen lamps can be used; these sources can be equipped with filters to suppress unwanted frequencies.

After the formation of the partially hardened film on the extensible support, to complete the extensible transfer film assembly it is possible to apply protective liners on the free side of the film and, if not applied before, also on the free side of the extensible support; lamination or other methods can be used for the applications of these liners.

To implement what stated above, it is important to consider the following points:
The layer forming mixture to be deposited on the extensible support must wet its surface; for this purpose the mixture must have a surface tension similar or possibly lower than that of the support, and this can be obtained with the use of suitable solvents and consequently with components of the mixture compatible with said solvents; an increase of the temperature during the deposition to produce a fast solvent evaporation could also help;
After drying, the layer must have a suitable internal cohesion (maintaining however the necessary extensibility), to resist the interfacial stress with the support during its formation and to maintain its dimension also during the subsequent transfer phases from the extensible support to the substrate (after a possible first hardening phase); to characterize the level of said internal cohesion, the yield stress of the material has been considered (yield stress: maximum stress at which the material maintains its elastic behavior).
To obtain the necessary internal cohesion, if the simple evaporation of the solvent is not enough, it is possible to adopt one or more of the following expedients:
   Add gelling fillers or additives to the layer composition;
   Add resins of high glass transition temperature (binders) to the layer composition;
   Partial polymerization of the layer after drying;
The adhesion between the layer and the extensible support must not overcome the internal cohesion of the layer and the adhesion between the layer and the substrate, otherwise the transfer cannot take place correctly. In case of problem of this type, the following expedients can be adopted:
   Use an extensible support having intrinsic lower adhesion with said layer;
   Add release agents to the layer forming mixture to reduce the adhesion with the extensible support;
   In case a hardening phase is adopted before the removal of the extensible support from the film, special care must be taken to avoid an excessive increase of the adhesion between them; one possibility is to choose a different material for the extensible support (for instance a very easy release one); another way out could be the choice of polymerization initiators and light sources in order to avoid the polymerization of the layer in contact with the extensible support during this phase.

### Multilayer Film

Unlike the known situations in which a layer is transferred from a temporary support to a final substrate and the layer is formed on other completely hardened layers (cross linked through a complete polymerization) to form a multilayer film, in the present invention the multilayer film must be formed with layers not completely polymerized. It is known that to obtain very thin layers like those requested in the present invention, the composition for the layer generation must be very diluted in a solvent to reduce the viscosity, otherwise too high, and to reduce the minimum thickness of the layer after drying. Deposition of this diluted composition on a not completely polymerized layer to form a new layer is often not practically possible because the solvent tends to destroy this layer, and this is what normally happens when a layer is formed on another layer not completely hardened, particularly when the thickness of the underlying layer is very low.

To avoid this problem a possible solution could be the use of two types of layers one comprising materials soluble only in a strongly polar solvent and the other only in a non polar one, and alternating them in the film formation, but this solution is not practical because it presents severe limitation in the choice of the materials.

Extrusion technologies (curtain or slot die or slide coating) as reported in the U.S. Pat. No. 2,761,791, U.S. Pat. No. 2,941,898, U.S. Pat. No. 3,508,947, U.S. Pat. No. 3,526,528, have been also analyzed but unfortunately these technologies are not always suitable because it is very difficult to obtain the thickness accuracy required for the low thickness of some of the layers of the invention applications (such as the interferential layers and the hydrophobic top layer, whose thicknesses are in the sub-micron range). These techniques however can be applied successfully for some of the layers of the invention applications (such as the antiscratch layer and the adhesion layer, whose thicknesses are much higher being in the micron range).

A more general solution has been found in which the layer is formed on a first temporary support 5, not necessarily extensible but having easy release properties and a very smooth optical grade surface (for instance a glassy or polymeric support superficially treated for easy release or a support intrinsically easy release like the silicone rubber); after the evaporation of the solvent the layer is transferred by lamination from the temporary support to the extensible support on which other layers partially hardened could be present. With this approach the contact of solvent with a not completely hardened layer is avoided.

This approach is possible if the following conditions are met:
1. feasibility of the layer deposition on the first temporary support surface, which is by its nature very repellent (easy release) and therefore difficult to wet. Same suggestions made for the monolayer film formation on this subject, are valid also in this case;
2. transferability by lamination of the dry layer from the first temporary support to the extensible support, which should met the following conditions:
   a. build up, during the lamination, of a sufficient adhesion between said layer and the other layers already present (if any) on the extensible support, enough to overcome the low adhesion with the first transfer support and assure a reliable transfer;
   b. sufficient adhesion at the various interfaces and cohesion of the layers already present (if any) on the extensible support to withstand the stress generated during the removal of the first temporary support and avoid permanent deformations.

As for the cohesion of the layers, the comments and suggestions made for the monolayer film are valid also in this case while for problems related to the adhesion at the interfaces one or more of the following expedients can be used:
use of layer compositions which can develop sufficient intrinsic adhesion at room temperature (25° C.) when put in contact whit the other layers, using also, if necessary, suitable additives (e.g. tackifiers, surface-active agents, adhesion promoters, etc);
after the lamination but before removing the temporary release support, make a partial polymerization (by heating or by irradiation with light) of the layer to be transferred in order to bond it to the multilayer film in formation on the extensible support, paying attention not to impair the necessary extensibility;
increase the temperature during lamination in order to partially soften the layer and increase the adhesion with the receiving surface;
insert thin adhesion layers (formed and transferred like all the other layers) between the layers during the multilayer film formation;

The adhesion of the layer in contact with the extensible support must be higher than that between the multilayer film and the temporary release support in order to allow the lamination, but not too high to prevent the transfer of the film to the substrate, as already stated for the monolayer film. Same suggestions made for the monolayer film on this subject, are valid then also in this case.

### Materials Used

### Extensible Transfer Film

### Generalities

As for the extensible and partially hardened layers which constitute the extensible transfer film 2, they are essentially made of a mixture (obtained after the complete evaporation of the solvents possibly added to help the layer formation) of monomers, resins and ultrafine particles to obtain or enhance the desired properties. Other components in low quantity can be also present like: initiators, polymerization catalyst, various types of additives like surface-active agents, colorants, adhesion promoters, tackifiers, gelling agents, releasing agents, etc.

The minimum cohesion necessary for these layers (measured by the yield stress) can be obtained after the evaporation of the possible solvents simply by the interaction among the components of the mixture or with a preliminary and partial hardening or both.

A simple solution to get a layer with a good cohesion level along with a suitable extensibility consists of adding to the layer forming mixture a proper amount of gelling agents like ultrafine particles properly dispersed to help the layer formation and confer it special rheologic properties like visco-elasticity. It is now worth recalling that visco-elastic materials behave like solids (and therefore have an elastic stress-strain portion if subjected to a mechanical stress below a certain value (the yield stress), and like viscous liquids over this value.

Another simple solution, possibly even combined with the previous one, consists in enriching the layer forming mixture with a sufficient amount of one or more thermoplastic resins with a suitably high glass transition temperature.

It is however important to note that these expedients could impact the hardness and/or the abrasion resistance of the layer after the final hardening, and for this reason it is preferable to use resins and/or dispersing agents of the ultrafine particles which can also be polymerizable and/or cross linkable in order to produce an efficient cross linking between said compounds and the rest of the other components of the mixture.

If the abovementioned expedients were not successful to produce the requested layer cohesion, it could be possible, in any phase of the formation of the multilayer film, to introduce a preliminary partial polymerization of some of the components of the layer composition. In this case it is important to distinguish the following two possibilities:
(1) partial pre-polymerization reaction mechanism of the same type used for the final hardening;
(2) partial pre-polymerization reaction mechanism different from that used for the final hardening.

In the following description, in all cases well known techniques are reported.

For what concerns the chemical formulation of the mixtures of the monomers or resins to use for the formation of the layers, it is considered first the case when only one mechanism of polymerization is present, common to both the final polymerization and the possible preliminary partial polymerization.

Generally speaking any kind of hardening monomers or resins can be used for such application, if sufficiently stable and then resistant for example to the light, to the humidity, to the temperature, and able to produce a good adhesion among the possible adjacent layers of the extensible transfer film.

The hardening mixture may harden by means of the temperature or of a radiation (typically electromagnetic radiation or an electron beam) through for example groups polymerizable by condensation, groups with double bonds polymerizable by radicalic or anionic or cationic mechanism, epoxy or oxetanic groups polymerizable by cationic mechanism, isocyanate groups polymerizable by reaction with hydroxyl or amino groups, alkoxysilane groups polymerizable by condensation, and others.

In particular, for their practical interest, as reticulating monomers the followings are mentioned, which contain at least two groups with double bonds of the acrylate type: 1,6-exandiol diacrylate, polyethylene glycol diacrylate, polypropylene glycol diacrylate, glycerine triacrylate, trimethylol propane triacrylate, tris(2-hydroxyethyl)isocyanurate triacrylate, pentaerythritol triacrylate, pentaerythritol tetraacrylate, dipentaerythritol pentaacrylate, dipentaerythritol esaacrylate, bisphenol-A diacrylate modified with ethylene oxide, bisphenol-A diacrylate modified with ethylene glycol diacrylate, bisphenol-A diacrylate modified with ethylene oxide/propylene oxide, bisphenol-A diacrylate modified with propylene oxide/tetramethylene oxide, adducts of bisphenol-A/diepoxy/acrylic acid, bisphenol-F diacrylate modified with propylene oxide/tetramethylene oxide, polyurethane acrylates, polyester acrylates.

Examples of thermoplastic resins which may be used are the following: polyester, polyurethanic, polyolephinic, polyether, polyacrylic, polymethacrylic, cellulosic, vinyl, and others.

Said resins may preferably be used also in its hardening versions, by thermal or radiation exposure, if they are provided with functional groups subsequently polymerizable as for example condensable groups or groups with double bonds polymerizable by radicalic mechanism or epoxy groups polymerizable by cationic mechanism.

For the synthesis of the above-mentioned resins reference is made to already well known techniques; to be noted however that in such cases polyfunctional monomers are broadly used, such as for example glycidyl acrylate, glycidyl methacrylate, 3,4-epoxycyclohexylmethyl acrylate, 3,4-epoxycyclohexylmethyl methacrylate, vinyl methacrylate, isocyanate ethyl methacrylate, 2-hydroxyethyl acrylate, 2-hydroxyethyl methacrylate, acrylic acid, methacrylic acid, and others.

Such monomers can be added advantageously even as they are to the composition of the mixture, for example when one or more partial polymerization phases are foreseen, or when the “dual curing” technique is utilized in order to increase the degree of cross-linking in the final hardening, or to link the colloidal particles possibly dispersed in the mixture in order to let them to take part in the final cross-linking, or in other cases as well.

Still concerning the resins, to mention finally the possibility of using also typically thermosetting resins such as for example the phenolic, phthalic, melaminic, epoxy, and so on ones.

When in particular the case is considered of hardening of the layer by irradiation with ultraviolet or visible light, it is necessary to add to the polymerizable mixture also one or more photoinitiators, that, premised obviously that they have to dissolve in the mixture, according to the application may be chosen of the radicalic type (for example acetophenone, benzophenone, bis-2,4,6-trimethylbenzoyl-phenylphosphin-oxide, 2-hydroxy-2-methyl-1-phenyl-propan-1-one, 1-hydroxy-cyclohexyl-phenyl-ketone, 2-isopropylthioxanthone, 4-isopropylthioxanthone, and many others) or of the cationic type (for example the “onium” salts as the salts of diaryl iodonium, triaryl sulphonium, monoaryl dialkyl sulphonium, triaryl selenonium, tetraaryl phosphonium, aryl diazonium, and others), and are activated with various frequencies of radiation ranging from the ultraviolet till to the visible light.

The action of such photoinitiators can be further enhanced by using opportune substances (“sensitizers”), such as for example organic amines like n-butylamine and tri-ethylamine, phosphines like tri-n-butylphosphine, and tioxanthone.

To be noted however that the same functional groups polymerizable through photoinitiators, on demand may be polymerized also through well known initiators and/or catalysts of thermal type, such as for instance peroxides or azo-bis compounds or others.

The organic hardening mixture may be used in combination with silicon containing organic compounds, subsequently described in three separate groups. Such compounds are part of the mixture composition typically to favour, if necessary, the adhesion among adjoining layers of the film or between the film and the final substrate, or they may even form the totality of the polymerizable and/or cross-linkable compounds.

The above mentioned three groups are the following ones:

### 1) Alkoxysilanes

The alkoxysilanes are compounds represented by the formula Rm Si(OR′)ₙ where R and R′ represent each an alkyl group having from 1 to 10 carbon atoms and m and n are integer numbers, where m+n=4.

Examples of alkoxysilanes suitable for the uses of the present invention comprise: tetramethoxysilane, tetraethoxysilane, tetra-iso-propoxysilane, tetra-n-propoxysilane, tetra-n-butoxysilane, tetrapentaethoxysilane, methyltrimethoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, methyldimethoxysilane, methyldiethoxysilane, and hexyltrimethoxysilane.

### 2) Silane Adhesion Promoting Agents

Examples of silane adhesion promoting agents suitable for the uses of the present invention comprise: β-(3,4-epoxycyclohexyl)ethyltrimethoxysilane, γ-methacryloxpropyltrimethoxysilane, γ-methacryloxpropylmethyldimethoxysilane, γ-glycidoxypropyltrimethoxysilane, methyltrimethoxysilane, vinyltriacetoxysilane, γ-mercaptopropyltrimethoxysilane, γ-chloropropyltrimethoxysilane, hexamethyldisilazane, vinyltris(β-methoxyethoxysilane, methyltrichlorosilane, and dimethyldichlorosilane.

### 3) Silicon Organic Compounds Usable as Hardening Resins.

Examples of such compounds suitable for the uses of the present invention include silicon organo-metallic compounds containing more functional groups able to give rise to cross-linking such as, for example, polymerizable groups with double bonds or polymerizable epoxy or oxetanic groups.

This type of compounds comprises polysilanes or polysiloxanes ending to an extremity or to both the extremities with one or more vinyl or acrylate or methacrylate groups, preferably acrylates groups. It comprises moreover polysilanes or polysiloxanes ending to an extremity or to both the extremities with one or more epoxy or oxetanic groups, preferably “3,4-epoxy-cyclohexyr groups.

Going on now to examine the second case, that is the one with a reaction mechanism of the partial polymerization distinct from that of the final polymerization, the chemistry used for the formulation of the components of the layers is more complex of the previously described one, but this fact gives important benefits in terms of mechanical properties of the layers.

By differentiating the mechanisms of polymerization in a first one devoted exclusively to the partial polymerization phase, and in a second one devoted exclusively to the phases of completion of the hardening during or after the transfer of the film to the substrate, makes it possible in fact to get the following advantages:

1) The control of the partial polymerization is simplified because it is simply brought to total conclusion, without necessity then to check the interruption of the same to an intermediate phase.
2) The stability in the time of the partially polymerized material during its storage before the final application is increased.
3) The already partially polymerized layers cannot be altered if for some reason they are further exposed to the agent which is causing the partial polymerization (for example the temperature or the light) during a possible phase of partial polymerization of a subsequent adjacent layer.

In regard to what is described in the preceding paragraph, the compositions of the materials to polymerize are similar in that already described for the case of single polymerization mechanism, but they need to have at least two different types of reactive groups.

Considering for instance the case of the resins hardening through ionizing radiation, compounds can be foreseen which contain both groups with double bond, of the type already described in the preceding case and polymerizable with radicalic mechanism for the partial polymerization, and epoxy or oxetanic or vinylether croups, polymerizable with cationic mechanism for the subsequent final hardening.

Consequently the first ones of such groups will be activated by photoinitiators of the radicalic type, the second ones by photoinitiators of the cationic type; obviously it is necessary that the last are not activated in concomitance of the phase of partial polymerization, which may be carried out with a correct choice of both the frequencies characteristic for the activation of the photoinitiators and the emission spectrum of the lamps, equipped if necessary with opportune optical filters capable to remove possible undesirable frequencies of irradiation (eventually even cold filters can be used, in order to filter the irradiation of the infrareds inevitably emitted from the lamps, that could determine an excessive overheating of the substrates to be coated and consequent damage of the same).

The phase of partial polymerization, that this time is brought to completion, will give then rise to polymers poorly linked and with high maximum elongation, while the second phase, once brought to completion, will produce the completion of the cross-linking of the polymer making then possible a high level of final hardening.

To be finally mentioned that is however even possible both the case of combinations between mechanisms characteristic of the resins hardening through radiations and that characteristic of the resins hardening through temperature, (obtained for example even only replacing simply the photoinitiators with thermal initiators, both radicalic and cationic), and the case of mechanisms based only on the temperature for both the partial and the final polymerization. This latter case requires however a suitable differentiation between the temperatures of the two polymerizations, and since for this reason the temperature of the final polymerization must be quite high, it may practically be used only for substrates materials that withstand even high temperatures such as for example the glass.

For what concerns instead the ultrafine particles that may be added to the mixtures for the formation of the layers to confer specific properties, very often they are oxides (but not always), in particular metallic oxides, kept in dispersion often by opportune dispersing agents and having an average diameter not greater than 0.5 micron, and preferably between 0.005 micron and 0.05 micron, in order not to produce an excessive haze.

The dispersing aforementioned agents, that may be both low molecular weight and polymeric compounds, may be bonded to the particles through a covalent type bond, as in the case for example of the silanes or of the isocyanates, or through a non covalent type bond, as in the case for example of dispersing agents containing groups of polar type having high affinity with the surfaces of the particles of the oxides. Such groups may be for example: hydroxyl, mercapto, carboxylic, phosphonic, phosphatic, sulphonic, sulphonamidic, amino, quaternary ammonic, cyclical anhydrides, and still others.

The dispersing agent preferably has one or more functional groups for a cross-linking during the final hardening combined with that of the layer forming mixture, as for example acrylate or methacrylate or amine or epoxy groups.

Techniques for the formation of the dispersions of ultrafine particles for uses similar to those of the present invention are already known, as those reported for example in the Japanese patent applications JP-A-2003-058579, JP-A-10-236340, JP-A-2001-049204, JP-A-10-188230, but are currently available even products from the market with concentrated solutions of ultrafine particles of different oxides types already dispersed in opportune solvents and/or monomers.

In conclusion and synthesizing, the mixture for the formation of an any of the layers of the film may be described as the combination, disregarding the solvents, of a first fraction (a) of polymerizable and/or cross-linkable monomers with a percentage ranging between 15% to 99.5% in weight, of a second fraction (b) of resins possibly polymerizable and/or cross-linkable with a percentage ranging between 0% to 60% in weight, of a third fraction (c) of solid particles inclusive of possible dispersants, eventually polymerizable and/or cross-linkable, with a percentage, varying according to the specific characteristics of the layer, ranging between 0% to 90% in weight, of a fourth fraction (d) of polymerization initiators and/or catalysts with a percentage ranging between 0.5% to 10% in weight, and of a fifth fraction (e) of additives of various kinds such as release agents, gel-forming agents, tackifiers, stabilizers and absorbers for UV, antioxidants, surface-active agents, coloring agents, adhesion promoters, and so on, with a percentage ranging between 0% to 20% in weight.

The aforesaid resins (b) may have a degree of polymerization and/or cross-linking ranging between 50% and 100%, preferably between 50% and 90%, where the expression “degree of polymerization and/or cross-linking” means the percentage of the polymerizable and/or cross-linkable groups that have already given rise to a bond, or to polymerization and/or cross-linking, in comparison with that initially introduced in the mixture.

Besides, depending on the type of use as previously mentioned, the film in accordance with the present invention may be constituted by an or more layers capable to confer one or more physical properties; such layers may have preferential compositions and thicknesses; in particular for what concerns these latter:
the layer capable to confer scratch resistance may have a thickness ranging between 0.5 micron and 50 micron, preferably between 2 micron and 10 micron
the layer capable to confer hydrophobic property may have a thickness ranging between 0.005 micron and 0.1 micron
the layers capable to confer interferential properties may have thicknesses ranging between 0.005 micron and 0.2 micron
the optional primer layer capable to enhance, if necessary, the adhesion of the film to the substrate may have a thickness ranging between 0.1 micron to 20 micron

In accordance with a further aspect of the invention, the components (a), (b), (c), (d) and (e) constitute 100% in weight of the film layers.

The mixture with the aforementioned composition may be diluted in one or more solvents to a concentration varying according to the deposition technique used and to the final thickness to be obtained for the dried layer and that is ranging from 0.1% to 100% in weight, and preferably from 1% to 50% in weight.

For what concerns the solvents, the preferred ones are organic solvents with different levels of volatility, polarity, and of surface tension in order to be able to adapt to the various situations of use, like for example alcohols (as methanol, monomethylether ethanol, propanol, isopropanol, butanol, propylenglycol, diacetone alcohol, etc.), ketones (as acetone, butanone, methylisobutylketone, cyclohexanone, etc.), esters (as ethyl acetate, butyl acetate, butyl lactate, butyrolactone, propylenglycol monomethylether acetate, propylenglycol monoethylether acetate, etc.), ethers (as ethylenglycol monomethylether, diethylenglycol monobutylether, etc.), aliphatic hydrocarbons (as hexane, cyclohexane, heptane, decane, etc.), aromatic hydrocarbons (as benzene, toluene, xylene, etc.), amides (as dimethylformamide, dimethylacetamide, n-methylpyrrolidone, etc.), fluorinated solvents (as 2,2,2-trifluoroethanol, 2,2,3,3,3-pentafluoro-1-propanol, ethyl-pentafluoropropionate, trifluoromethyl-endecafluorohexane, etc.) or mixtures of the same.

Among the others, mostly preferred are the followings: methanol, ethanol, propanol, isopropanol, diacetone alcohol, acetone, butanone, methylisobutylketone, cyclohexanone, ethyl acetate, hexane, heptane, toluene, 2,2,2-trifluoroethanol.

It follows an essential description of meaningful components that may be used in the mixtures for the formation of the different types of layers.

### Antiscratch Transparent Layer

To increase the hardness and the Young module of the anti-scratch layer and also to reduce the stress produced during the final hardening, typically 20% to 80% in weight of inorganic nano-particles is added to the mixture described above. When the percentage of these particles is lower than 20% in weight, the desired effects of preventing fractures and separation of components inside the layer composition and reducing the stress after hardening could not be obtained, while over 80% in weight, problems of film transparency could arise.

The addition of the above described nanoparticles helps to improve the resistance to the “Steel Wool test” of the anti-scratch layer, but it is important to note that if also a good impact resistance and “Bayer test” resistance is required, some restrictions to the compositions of the reticulating monomers and resins must be applied. In particular, as described for instance also in the USA patent application US 2005/0171231, a certain amount of a flexible long-chain difunctional monomer capable of co-reacting with the other functionalized components of the mixture must be added in order to increase the flexibility of the layer after the curing.

Inorganic ultrafine particles for this application include: silicon dioxide, aluminum sesquioxide, magnesium carbonate, aluminum hydroxide and barium sulfate. In order to increase the dispersion of the particles in the resin, the transparency and the hardness of the hardened film, it is possible to use suitable dispersing agents, with or without functional groups for the final polymerization, or to treat the particles with adhesion promoters (silane coupling agents or the like). The composition of the mixture for the antiscratch layer can include other additives like for instance: surface-active agents, UV stabilizer, UV absorber, antioxidants, gelling agents, etc.

In particular, besides those used to increase the hardness, also colloidal fillers to increase the refraction index can be used to avoid optical defects (like interferential fringes when a good transparency is required) when the substrate has a high refraction index.

Such fillers can be oxides of Sb, Ti, Zr, Al, Ce, Sn, W or a mixture of them, as well as mixed oxides of them (composite particles of such oxides).

The amount of colloidal filler mentioned above can reach 50% in weight of the layer composition.

Finally, it is worth mentioning that the antiscratch layer can be made of more layers in order to increase, if necessary, the hardness and/or the impact resistance.

### Transparent Hydrophobic Layer

Resins with low surface tension, (such as the silicone or fluoro resins), having functional groups for polymerization and final hardening, are used. To this aim it is possible for instance to synthesize by radicalic reaction, copolymers of fluorinated acrylate or methacrylate monomers having completely fluorinated linear chains groups (10 to 30 carbon atoms long), with acrylate or methacrylate monomers having epoxy or double bonds function for the final cross linking (note: the double bond function may be introduced trough a second reaction between hydroxy or carboxy groups present in the acrylate polymer and suitable isocyanate multifunction monomers).

Therefore in this case the initiator must be radicalic or cationic activated by heating, or preferably by light in case of organic substrates, to which a sensitizer can be added to increase its efficiency even at wavelength close to the visible light.

The glass transition temperature of such polymers ranges typically between 50° C. and 100° C., and this helps adhesion, otherwise low, of this layer with the surfaces with which it is joined during possible hot lamination.

### Low Index Transparent Layer

The previously basic resin described above can be simply used, with or without the addition of dispersed low index particles of quartz, being this layer already with low index (typically 1.45 to 1.55, low enough to be used for interferential multi-layers like the antireflection ones).

To further reduce the refraction index (to about 1.4), low index particles dispersions can be added to the resin, like hollow particle of silicon dioxide (with internal cavities or porosity with total empty volume greater than 10% of that of the particles), or particles of metallic fluorides like magnesium fluoride, calcium fluoride, barium fluoride.

To obtain the lowest possible refraction index layers (to about 1.3), the above resin can be substituted in part or totally with a cross linkable fluoro resin, obtaining in this case also a low surface tension and therefore hydrophobic property and antismudge property.

### Medium or High Index Transparent Layer

To increase the refraction index of a layer to obtain the medium and high index layers, the basic hardening resin can be added with dispersion of inorganic ultrafine particles having refraction index between 1.50 and 2.70. Specific examples of these ultrafine particles include powders of ZnO (refraction index 1.9), TiO2 (r.i. 2.3 to 2.7), CeO2 (r.i. 1.95), Sb2O5 (r.i. 1.71), SnO2, indium-tin oxide (ITO) and antimony doped indium-tin oxide (ATO) (both with r.i. 1.95), Y3O2 (r.i. 1.87), La2O3 (r.i. 1.95), ZrO2 (r.i. 2.05), Al2O3 (r.i. 1.63), C (diamond, r.i. 2.4).

In case of use of ATO or ITO, besides the increase of the refraction index, the layer acquires also appreciable electrical conductivity, still maintaining its transparency (for this reason these materials are frequently used also for the production of displays and optoelectronic devices).

In addition, to form high and medium index layers, besides the ultrafine particles also resins with particular molecules e/o atoms (like sulfur, nitrogen, phosphor, various fluorine halides, aromatic rings, etc.) having refraction indexes 1.6 and sometimes over 1.7, can be used; in these cases the refraction index of the layer can be higher than 2.2.

### Transparent Layer for Interlayer Adhesion

In this case adhesion property is required even before the final hardening, and therefore acrylic adhesives having functional groups for the final polymerization and hardening could be used, like for instance copolymers of acrylic or methacrylic acid and acrylates or methacrylates whose homopolymers posses low glass transition temperature, with the presence in the copolymer also of acrylates or methacrylates having epoxy or double bonds function for the final cross linking and possibly also silane adhesion promoters.

Also in this case the initiator must be radicalic or cationic activated by heating or preferably by light in case of organic substrates, to which a sensitizer can be added to increase its efficiency even at wavelength close to the visible light.

### Transparent Layer for Substrate Adhesion (Primer Layer)

This layer, if requested, is designed for the specific characteristics of the substrate to be coated. It can be formed, for example, by a mixture of various multifunctional monomers, such as acrylates, together with a binder, not hardenable such as for instance polymethylmethacrylate, or hardenable such as for instance an acrylate copolymer having, like in the previous case, epoxy or double bonds groups for the final cross linking and the adhesion with the substrate, and additional alkoxysilane groups as adhesion promoting agents.

Also in this case the polymerization initiator is radicalic, preferably photoradicalic, and/or cationic, preferably photocationic added with sensitizer.

A solvent with low surface tension can be used for the formation of the layer on a temporary release (low adhesion) support, or another more compatible with the substrate to be coated (like for instance an alcohol) in the case the layer is spread directly on the substrate before the application of the film.

If the layer is formed with the drop of adhesive put on the substrate immediately before the film application, it is important that the drop does not contain solvents and does not damage the layer on which it comes into contact. In addition, said adhesive material should have a low viscosity in order to allow the formation of a thin layer, and have a reflection index as similar as possible to that of the substrate to minimize or avoid unwanted interferential effects.

### Colored Layer

Same mixtures reported in the previous cases can be used, simply by adding dyes or pigments of the type necessary to obtain the desired color. When possible these coloring materials should have functional groups to contribute to the final hardening and grant maximum hardness and stability of the product during its life.

### Extensible Support

Various types of materials can be used, like those derived from cellulose, polyesters, polycarbonates, polyamides, polyolefins, silicone rubbers, etc. Preferred are for instance materials like silicone rubbers, polyester terephtalate (PET) and polycarbonate (PC), coated or not with thin layers of release material to reduce adhesion, like for instance some olefin, silicon or fluorinated polymer.

### Protective Liners

There are not particular limitations; they are typically made of polymeric materials when the adhesion is generated with electrostatic force, or of polymeric or paper like materials coated or not, when the nature of the adhesion is physico-chemical.

### Preferred Embodiments

FIGS. 5, 6 and 7 describe a preferred embodiment of a procedure for the production of a two layer extensible transfer film, which is representative also of films having one or more than two layers.

The process sequence is as follows:
1° phase: formation of the first layer
(a) Spreading of the material for the first layer 2a on the surface of the extendible support 1 (possibly already equipped with the protective liner 4).
(b) Drying of said first layer 2a immediately after its spreading. After the evaporation of the solvents, the layer acquires enough internal cohesion and extensibility to allow subsequent transfer processes.
2° phase: formation of the second layer
(c) Spreading of the material for the second layer 2b on the surface of the easy release support 5 which has a very low superficial adhesion, lower than that of the transferable support 1;
(d) Drying of said first layer 2b immediately after its spreading. Also in this case, after the evaporation of the solvents, the layer acquires enough internal cohesion and extensibility to allow subsequent transfer processes;
(e) Lamination of the dry layer 2b on the dry layer 2a;
(f) Removal of the easy release support 5 from the layer 2b. This is possible without damaging the layers if the adhesion between the easy release support 5 is lower than: that between the dry layer 2a and the extendible transfer support, that between the two layers 2a and 2b, and the yield stress of these two layers;
3° phase: completion
(g) Possible application by lamination of the protective liner 3 and 4 (or only the liner 3 if the liner 4 were already applied before).

In the case of single layer film, the 1° phase is skipped (points from (c) to (I) included), while in case of film with more than two layers, phase two will be repeated accordingly.

If the polymeric materials forming the layer do not behave as indicated in points (b) and (d) above, it is possible to proceed with additional hardening phase consisting of a partial polymerization as previously indicated.

As for these possible partial polymerization phases, they can be performed by heating (with hot gas or IR), UV and/or visible light, or by an electron beam.

### Process for Applying the Extensible Transfer Film to a Substrate

### Generalities

The film, according to the present invention, can be applied to flat surfaces (or in general with zero curvature) or curved surfaces like for instance convex or concave. In addition these surfaces can be those of plastic or mineral substrates, like for instance lenses.

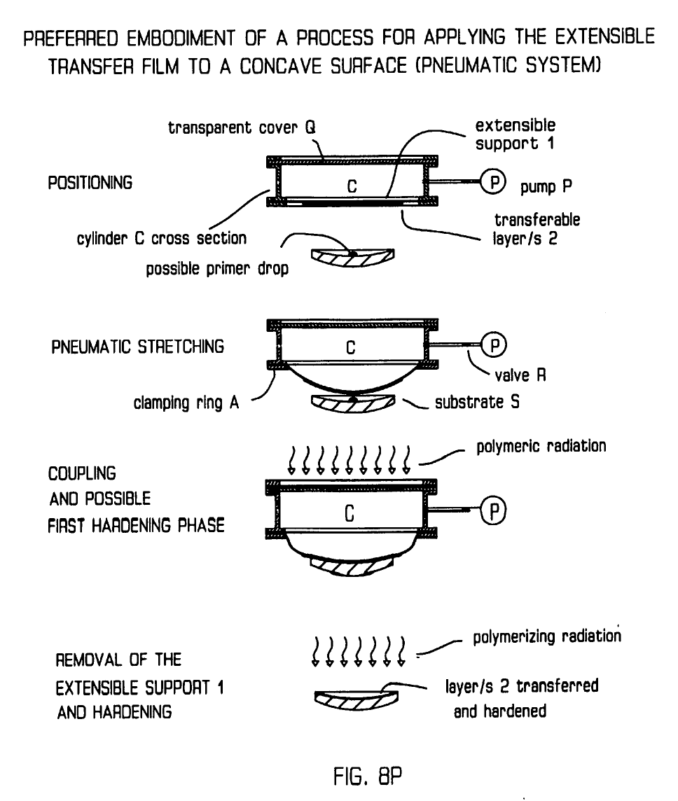

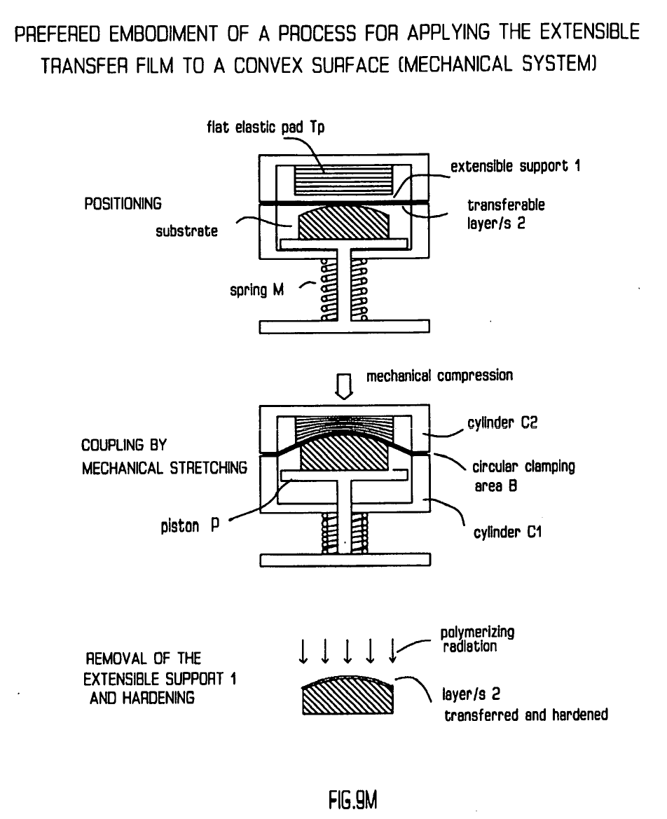

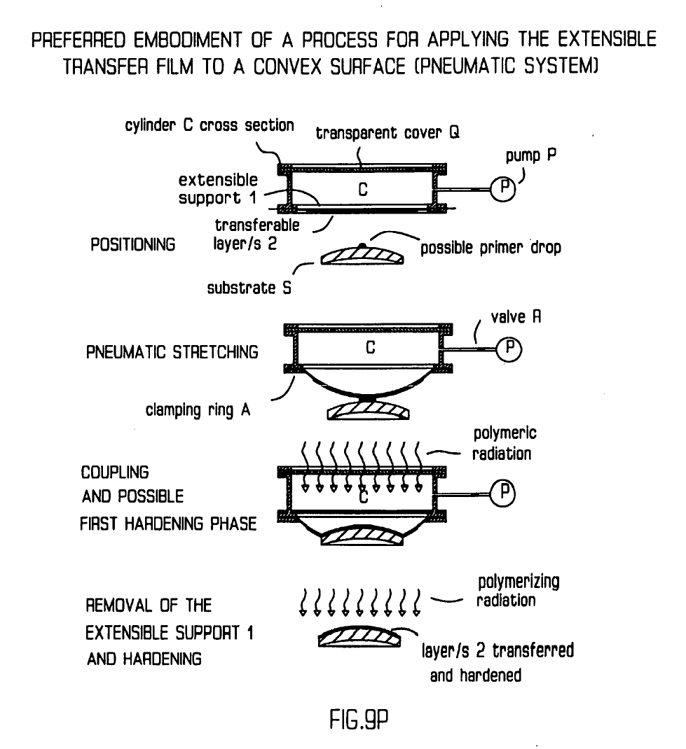

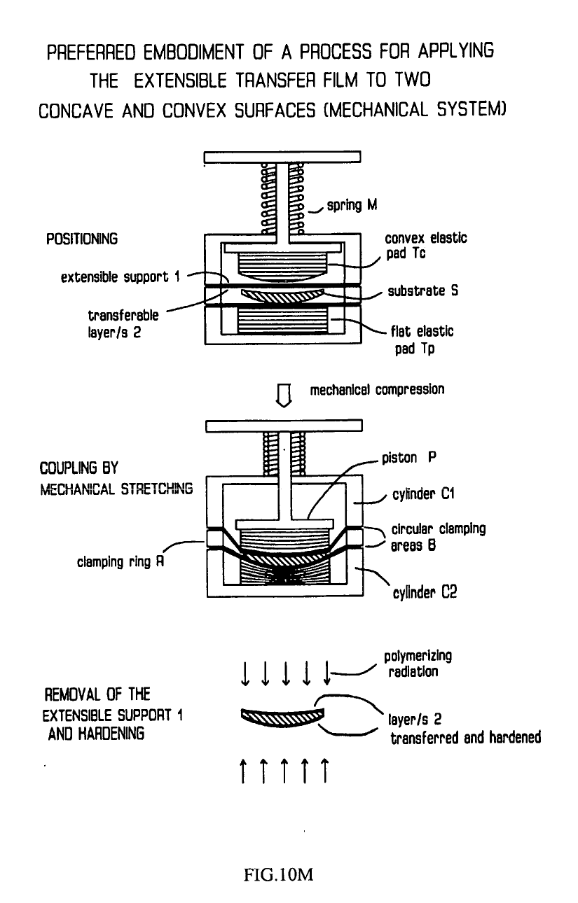

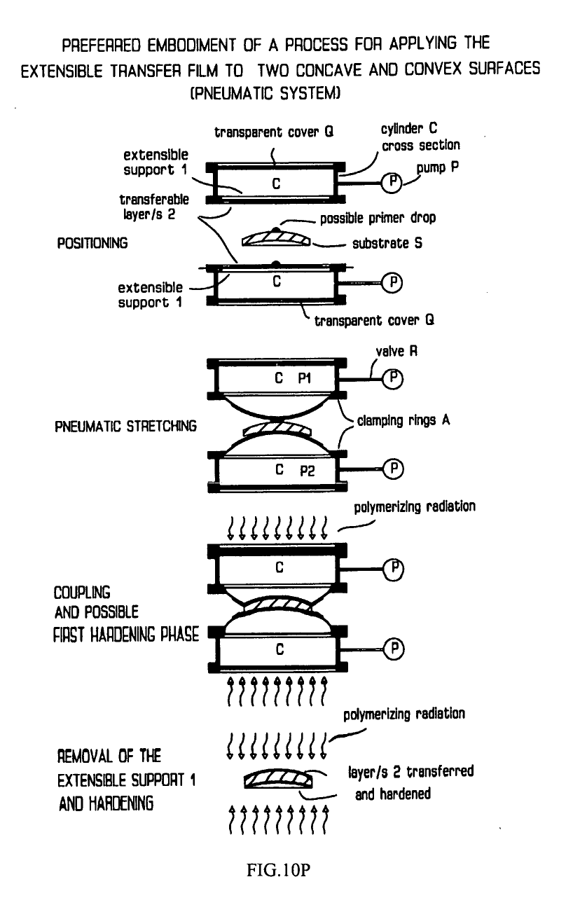

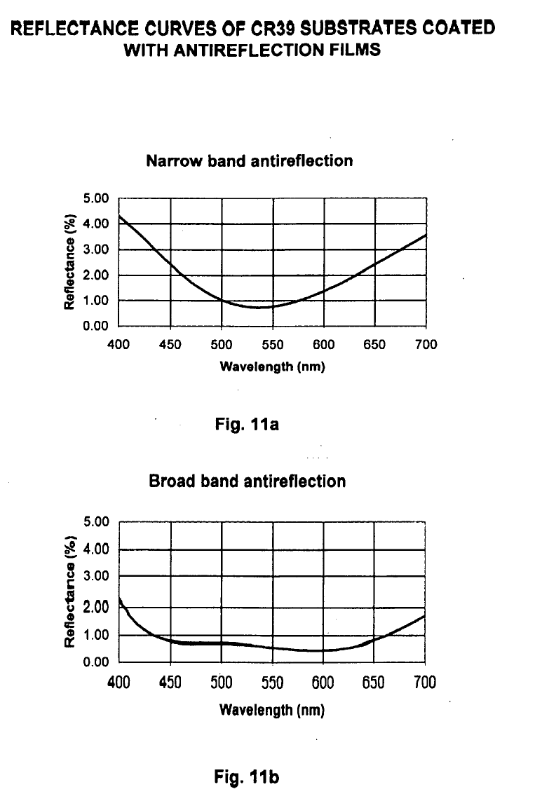

FIG. 3 describe the general principle for applying the film, related as example to the case of a concave surface; however the described method has a general validity and can be carried out also without the last step (g) of the 2° hardening phase.

The following are the application steps:
(a) Removal of the protective liners (if any) 3 and/or 4 from the extensible transfer film assembly;
(b) Positioning of the remaining extendible transfer support 1 and the film 2 with the film facing the substrate S;
(c) homogeneous stretching of the support 1 and film 2 to assume a curvature as close to that of the substrate S as possible;
(d) mechanical coupling of the film 2 and the extensible support 1 with the surface of the substrate S;
(e) 1° possible hardening phase of the film 2 with UV/visible light and/or heating;
(f) removal of the extensible support 1;
(g) 2° hardening phase of the film 2 with UV/visible light and/or heating.

The film hardening can be carried out in a single phase, both before or after the removal of the extendible transfer support (step (f)) or in two separated steps: before and after the step (f).

The maximum possible temperature reached during the final polymerization will depend on the nature of the substrate to be coated and will not be higher than 100° C. for plastic substrates, while for mineral substrates can go up to 400° C.

### Preferred Embodiments

### Pneumatic System

Schematically, this system is comprising an hollow cylinder C in which one of the two openings is closed with a transparent cover Q, preferably made of quartz transparent to UV, and the other opening is closed with the extensible transfer film assembly comprising the extensible support 1 and the film by the clamping and sealing ring A.

The inner part of the cylinder, which in these conditions is airtight, is connected to a pump which develops the necessary pressure to inflate the extensible transfer film assembly.

FIGS. 8P, 9P and 10P illustrate the preferred application procedures of the transferable layers 2 on concave and/or convex of a substrate (for instance of ophthalmic lenses), by means of the pneumatic system described.

FIG. 8P describes the case of a concave ophthalmic lens, according to the following procedure, after the removal of the possible protective liners 3 and 4:
(a) Positioning and clamping of the remaining support 1 and film 2 on the free opening of the cylinder C with the film facing the substrate S as illustrated in the drawing. To improve the adhesion a small drop of primer can be interposed between the substrate and the film, and spread during the transfer by pressure in the following step (c); alternatively the primer can be part of the film or can be spread on the substrate surface before the transfer.
(b) With the pump P the internal pressure of the cylinder is increased until the surface of the film reaches a curvature similar to that of the substrate to be coated.
(c) The coupling between the film and the substrate is carried out approaching the substrate to the cylinder until the coupling is complete. In the case of coating of concave surfaces, as in this case, the curvature of the film should be slightly higher than that of the substrate in order to start the contact between the surfaces in the center of the substrate and extend said contact to the rim of the substrate as the coupling proceeds: this is necessary to avoid air trappings. It is worth noting that with this system the thickness of the film on the coated substrate is more uniform than that obtained with the vacuum evaporation.
(d) A possible hardening phase of the film 2 is performed, with light exposition of the film through the transparent side of the cylinder and the extensible support 1 if this is sufficiently transparent, otherwise by heating. In this phase the film develops an increase of adhesion with the substrate S.
(e) Removal of the extensible support 1.
(f) 2° hardening phase of the film 2 with light or heating.

The described transfer approach is possible on concave or convex surfaces either with constant curvature (like for instance flat or spherical ones, typical of the majority of the ophthalmic lenses), or variable curvature (like for instance that of toric progressive ophthalmic lenses).

In a similar way FIG. 9P illustrates the case of film transfer on a convex surface of an ophthalmic lens; in this case the air trapping problem is not present due to evident geometrical reasons.

FIG. 10P describes the case of simultaneous application of the film on both surfaces of an ophthalmic lens; it is evident from the figure that in this case there is a combination of the procedures described in FIGS. 8P and 9P. This solution is not possible with the vacuum evaporation technology.

### Mechanical System

Schematically this system comprises two hollow coaxial cylinders C1 and C2 of the same diameter, closed on one side' and facing each other on the rims of the open sides. Cylinder C2 contains a piston P which can be lowered overcoming the force of the spring M by means of an external pressure. The extensible transfer film assembly comprising the extensible support 1 and the film 2 is positioned between said facing rim surfaces of the cylinders. Lowering of the piston, the film is first clamped between the rims of the cylinders an then, as the piston continues its stroke, coupled with the substrate by means of elastic pads Tc (for coupling with concave substrates) and/or Tp (for coupling with convex substrates).

FIGS. 8M, 9M and 10M describe the preferred embodiments for the application procedures of the transferable layers 2 on concave and/or convex surface of substrates (like for instance ophthalmic lenses) by means of the described mechanical system.

This approach is simpler than the previous one (specially using elastomeric supports like for instance silicone rubber) and can be used when there is no need for a 1° hardening phase with light before the removal of the extensible support 1.

In FIG. 8M the application is performed on a concave side of an ophthalmic lens according to the following steps after the removal of the protective liners 3 and 4:
(a) Positioning of the remaining support 1 and film 2 between the two open sides of the facing cylinders C1 and C2 with the film oriented to the substrate S and the extensible support oriented to the elastic pad Tc as illustrated in the figure. To improve the adhesion a small drop of primer can be interposed between the substrate and the film, and spread during the transfer by pressure, in the following step (c); alternatively the primer can be part of the film or can be spread on the substrate surface before the transfer.
(b) By lowering the piston P, the elastic pad forces the film to assume a curvature similar to that of the substrate to be coated.
(c) The coupling between the film and the substrate takes place by further lowering of the piston till the complete coupling of the two surfaces. In the case of coating of concave surfaces, as in this case, the curvature of the film should be slightly higher than that of the substrate in order to start the contact between the surfaces in the center of the substrate and extend said contact to the rim of the substrate as the coupling proceeds: this is necessary to avoid air trappings.
(d) First possible hardening phase of the film 2, which in this case can be done only by heating. In this phase the film develops an increase of adhesion with the substrate S.
(e) Removal of the extensible support 1.
(f) Second hardening phase of the film 2, with light o by heating.

Also with this system the described transfer approach is possible on concave or convex surfaces either with constant curvature (like for instance flat or spherical ones, typical of the majority of the ophthalmic lenses), or variable curvature (like for instance that of toric progressive ophthalmic lenses).

In a similar way FIG. 9M illustrates the case of film transfer on a convex surface of an ophthalmic lens; in this case the pad can have a flat or convex surface; the air trapping problem is not present due to evident geometrical reasons.

FIG. 10M describes the case of simultaneous application of the film on both surfaces of an ophthalmic lens; it is evident from the figure that in this case there is a combination of the procedures described in FIGS. 8M and 9M. This solution is not possible with the vacuum evaporation technology.

### EXAMPLES

Experimental tests have been made concerning on one hand the preparation of extensible transfer film assemblies to be used in the production of coatings on ophthalmic lenses, displays, screens, or whatever, having specific properties, and on the other hand their application with the previously described processes.

The invention is described more in detail in the following examples with the aim of showing possible solutions for some specific cases, but which must not be interpreted as limitative of the possibilities of the invention itself.

For simplicity of description and comparison among the given experimental data, in all of the examples the phases of application of the possible protective liners to the extensible transfer film assembly are omitted, and for what concerns the application of the film to the substrate it is performed only on the convex side of a ophthalmic lens having diopter −2.00 and diameter 70 mm made of ADC (Allyl-Diglycol-Carbonate, material often known even with the trademark of CR39® from PPG Industries Co.), since such type of lens is normally used as reference in the laboratory tests for the industry needs.

The simplification introduced in the examples doesn't compromise obviously the possibility to consider also cases of concave surfaces (or contemporarily convex and concave) of such substrates and/or cases of substrates made of materials different from the CR39, using if necessary additional layers of adhesion primers, and omitting eventually the use of hardening layers in case of substrates having already high hardness such as, for instance, the glass.

To be mentioned finally that, where not otherwise specified, all the percentages of the compositions of the mixtures shown in the examples are referred to ratios of weight/weight.

### Test Methods

### Evaluation of the Extensible Transfer Film Assembly

1. Linear maximum elongation of the extensible support: measured according to ASTM D882; the elongation is expressed as percentage ratio between the variation of length and the initial length.
2. Yield stress and maximum linear elongation of the layer: both measured according to standard ASTM D1708, using to the purpose, for handling reasons, a sample similar to the layer to be measured but with about 250 micron in thickness, pulled during the measure at a speed of 20 mm/min. To produce the sample a small basin of glass was used, whose flat bottom has been treated superficially with a thin “easy release” silicone layer (to the purpose the material RTV615 from GE Bayer Silicones was utilized); the basin was filled with the mixture to be used for the formation of the layer and subsequently heated gradually up to 120° C. by 30′ to evaporate entirely the solvents. The yield stress is expressed in Pascal (Pa), while the elongation is expressed as percentage ratio between the variation of length and the initial length.
3. Adhesion between layer and extensible transfer: measured by “Tack test” according to standard ASTM D2979, using as connection between layer and measuring device a disk of optic glass of 5 mm diameter previously pressed with strength on the same and pulled with a load increasing at a speed of 4 g/sec. Being the extensible support a surface more release than the optic glass, if the cohesion of the layer is sufficiently high normally a separation take place at the interface between layer and transfer support. The adhesion in such interface is expressed in Pascal (Pa).

### Evaluation of the Coated Lens

1. Haze: measured according to standard ASTM D1003 by means of a haze meter mod. Hazegard Plus from BYK-Gardner. It is expressed as percentage of the incident light.
2. Dry adhesion: on the coating a “Crosshatch adhesion test” is made according to standard Colts Laboratories L-12-12-01 (formation by blade of a grid of 10×10 cuts spaced 1 mm, followed by application of a transparent cellophane adhesive tape which is then pulled away quickly at an angle of 90°), and the number of peel-off produced in the grid from the pull is reported.
3. Adhesion after exposure to boiling water: the lens, according to standard Colts Laboratories L-12-15-01, is submitted to dipping in boiling water for a period of 15′, and the adhesion of the coating is then evaluated by “Crosshatch adhesion test” as already described in the preceding point 2.
4. Adhesion after exposure to QUV accelerated aging: the lens, according to standard Colts Laboratories L-17-21-01 (modified by prolonging the test duration from 1 day up to 10 days), is submitted to the exposure to alternate cycles of UVB and condensation, and the adhesion of the coating is then evaluated by “Crosshatch adhesion test” as already described in the preceding point 2.
5. Scratch resistance: measured by “Steel-Wool test” according to standard ISO/CD 15258 (the level of the damage caused by repeated rubbing with standard steel wool type “000” is evaluated through a measure of haze, made by means of a haze meter). The scratch resistance of the coated lens is then expressed as the ratio of the haze obtained in the test with the coated lens to that obtained with the uncoated lens.
6. Abrasion resistance: measured by “Bayer Test” according to standard ISO/CD 15258 (the level of the damage caused from a repeated shaking with standard alumina-zirconia grit is evaluated through a measure of haze, made by means of a haze meter). The abrasion resistance of the coated lens is then expressed as the ratio of the haze obtained in the test with the coated lens to that obtained with the uncoated lens.
7. Hydrophobic property: evaluated by means of the water contact angle of a water droplet on the coating surface. The higher the contact angle, the higher the hydrophobic property.
8. Reflectance: it is measured through a spectrophotometer (Lambda 20 from Perkin Elmer, Inc.) the curve of reflectance in the range of wavelengths from 400 to 700 nm in the center of the lens at a light incidence angle of 6°.

### Hardcoat Films

### Example 1A

### Transparent Hardcoat Film

This example describes an acrylate based film which can be applied to CR39 lenses without any adhesion layer, and which is producing a coating with a good Steel-Wool ratio.

### Preparation of the Mixture for the Formation of the Hardening Layer

A mixture is made containing 45.4% of the product MIBK-ST from Nissan Chemical Co (a dispersion in methyl-isobutylketone of 31% of silicon dioxide colloidal particles, including dispersant), 9.1% of an highly cross-linking acrylic monomer (penta/esa-acrylate dipentaerythritol, available from Sigma-Aldrich Co.), 4.5% of acrylic acid, 0.9% of a radicalic photoinitiator (Irgacure 1000 from Ciba Specialty Chemicals), and 40.1% of 2,2,2-trifluoroethanol.

Such mixture has a solid content equal to about 30% and it gives rise to a layer having a composition of about 47% of monomers, 50% of dispersed silicon dioxide particles, and 3% of polymerization initiators. The mixture is then shaken up to complete homogenization, and subsequently filtered across a polypropylene 0.4 micron filter.

### Preparation of the Extensible Transfer Film Assembly

The above mentioned mixture is deposited at a temperature of about 25° C. by means of a plant equipped with “metering rod” (Meyer rod) on a 1 mm thick sheet of optic quality silicone rubber with “controlled” release properties and subsequently dried at 120° C. for 10′.

Said sheet of silicone rubber is obtained by thermal polymerization of the resin LSR 70 from GE Bayer Silicones Co. in optic glass molds, followed by a room temperature superficial treatment of the sheet with a solution of 10% of titanium IV butylate in n-hexane and afterwards a drying step at 120° c. for 10′; it performs at 25° C. a linear maximum elongation higher than 200%.

The deposition process parameters are set in order to produce a layer with a dry thickness of about 8 micron.

The evaluation tests carried out on the sample layer prepared as described above, produced the following results:
1. Yield stress and linear maximum elongation of the layer: The observed yield stress was about 5.0E5 Pa, while the maximum elongation was higher than 100%.
2. Adhesion between layer and extensible transfer support: The resulting adhesion was about 5.4E4 Pa. To be noted that such adhesion value is lower than the yield stress of the layer by a factor of about 100, and it is lower as well than that measured between the same type of layer coated on a flat CR39 sample and the CR39, which was higher than the tensile stress of the layer (in fact during the test a cohesive fracture was produced inside the layer).

### Application of the Film and Evaluation of the Coated Substrate

The process of transferring the film from the extensible transfer film assembly to the lens is made, as already shown in the invention detailed description section, by means of a proper transferring apparatus of the mechanical type. Afterwards the coating is hardened by exposure to UV light in an atmosphere free from oxygen (for this purpose a 400 W UV lamp mod. 5000 EC from DYMAX Co. was used, complete with type “D” bulb and nitrogen purging system).

The evaluation tests carried out on the lens coated as described above, produced the following results:
1. Haze: less than 1%.
2. Dry adhesion: No peel-off has been observed after the “Crosshatch test”.
3. Adhesion after exposure to boiling water: No peel-off has been observed after the “Crosshatch test” made on the lens following its exposure to the boiling water.
4. Scratch resistance: 9.5 times that of the uncoated lens according to the “Steel Wool Test”.
5. Abrasion resistance: higher than that of the uncoated lens according to the “Bayer Test”.

### Comparative Example 1B

### Transparent Hardcoat Film

### Preparation of the Mixture for the Formation of the Hardening Layer

In a manner like that shown in example 1A, a mixture was prepared which was containing the same substances and dosages of said example, with the exception of the following modifications:
(a) The dosage of the product MIBK-ST from Nissan Chemical is halved.
(b) The acrylic acid is omitted.

The mixture is then shaken up to complete homogenization, and subsequently filtered across a polypropylene 0.4 micron filter.

### Preparation of the Extensible Transfer Film Assembly

In a manner like that shown in the previous example a layer with a dry thickness of about 6 micron is coated on a 1 mm thick sheet of optic quality silicone rubber with “controlled” release properties and subsequently dried at 120° C. for 10′.

The evaluation tests carried out on the sample layer prepared as described above, produced the following results:
1. Yield stress and linear maximum elongation of the layer: The observed yield stress was about 4.1E4 Pa, while the maximum elongation was higher than 160%.
2. Adhesion between layer and extensible support: The resulting adhesion was about 6.2E4 Pa. To be noted that in this case, unlike the previous example, such adhesion value is instead higher than the yield stress of the layer. However the adhesion measured between the same type of layer coated on a flat CR39 sample and the CR39 was again, as in the previous example, higher then the tensile stress of the layer (during the test a cohesive fracture was produced inside the layer).

### Application of the Film and Evaluation of the Coated Substrate

The process of transferring the coating from the extensible transfer film assembly to the lens by means of a transferring apparatus of the mechanical type was unsuccessful, because during the operation the layer was cohesively fractured. Such a result was foreseeable from the analysis of the reported data about measured adhesion and yield stress.

### Example 1C

### Transparent Hardcoat Film

This example describes an epoxy based film which can be applied to CR39 lenses without any adhesion layer, and which is producing a coating with both good Steel-Wool ratio and good Bayer ratio.

### Preparation of the Mixture for the Formation of the Hardening Layer

A mixture is made containing 75.8% of the product MT-ST from Nissan Chemical Co (a dispersion in methanol of 31% of silicon dioxide colloidal particles, including dispersant), 20.2% of a linear bifunctional epoxy monomer (1,4-butanediol diglycidyl ether, available from Sigma-Aldrich Co.), 2.5% of a silanic crosslinker (3-glycidoxypropyl-trimethoxysilane, available from Sigma Aldrich Co.), 2.5% of a gelling agent (polyethylene glycol methacrylate Mn 526, available from Sigma Aldrich Co.), and 1.3% of a cationic photoinitiator (Irgacure 250 from Ciba Specialty Chemicals).

Such mixture has a solid content equal to 50% and it gives rise to a layer having a composition of about 45.5% of monomers, 47% of dispersed silicon dioxide particles, 5.1% of additives, and 2.5% of polymerization initiators. The mixture is then shaken up to complete homogenization, and subsequently filtered across a polypropylene 0.4 micron filter.

### Preparation of the Extensible Transfer Film Assembly

In a manner like that shown in the previous example 1A a layer with a dry thickness of about 8 micron is coated at 50° C. on a 1 mm thick sheet of optic quality silicone rubber with “controlled” release properties and subsequently dried at 80° C. for 2′.

The evaluation tests carried out on the sample layer prepared as described above, produced results close to those reported in example 1A.

### Application of the Film and Evaluation of the Coated Substrate

The application procedure is similar to that shown in example 1A.

The evaluation tests carried out on the coated lens produced the following results:
1. Haze: less than 1%.
2. Dry adhesion: No peel-off has been observed after the “Crosshatch test”.
3. Adhesion after exposure to boiling water: No peel-off has been observed after the “Crosshatch test” made on the lens following its exposure to the boiling water.
4. Scratch resistance: 15 times that of the uncoated lens according to the “Steel Wool Test”.
5. Abrasion resistance: 3.7 times that of the uncoated lens according to the “Bayer Test”.

### Example 1D

### Primer Layer

The aim of this optional layer is to increase when necessary the adhesion between the hardcoat layer and the substrate after the final hardening, and also to broaden the list of substrate materials which can be successfully coated with a particular extensible film. It is used in the next two examples, but it can be used whenever helpful and without limitations also in all of the other examples particularly if materials different than CR39 are to be considered.

### Preparation of the Mixture for the Formation of the Primer Layer

A mixture is made containing 12.9% of a 20% solution in 2,2,2-trifluoroethanol of an acrylic high Tg binder (polymethylmethacrylate co-methacrylic acid, molar proportion of methyl methacrylate to methacrylic acid equal to 1:0.16), available from Sigma Aldrich), 2.9% of an highly cross-linking acrylic monomer (pentaerythritol tetraacrylate, available from Sigma-Aldrich Co.), 2.9% of an acrylic monomer tackifier (bisphenol A glycerolate 1-glyceroUphenol diacrylate, available from Sigma Aldrich), 0.3% of a radicalic photoinitiator (Irgacure 1000 from Ciba Specialty Chemicals), 40.85% of ethanol and 40.85% of 2,2,2-trifluoroethanol.

Such mixture has a dilution ratio of solid content to solvent equal to 8% and it gives rise to a layer having a composition of about 64% of monomers, 32.3% of thermoplastic resin, and 3.2% of polymerization initiators. The mixture is then shaken up to complete homogenization, and subsequently filtered across a polypropylene 0.4 micron filter.

### Preparation of the Extensible Transfer Film Assembly

In a manner like that shown in the previous example 1A a layer with a dry thickness of about 5 micron is coated at 50° C. on a 1 mm thick sheet of optic quality silicone rubber with “controlled” release properties and subsequently dried at 80° C. for 2′.

The evaluation tests carried out on the sample layer prepared as described above, produced results close to those reported in example IA.

### Application of the Film and Evaluation of the Coated Substrate

The application procedure is similar to that shown in example 1A.

The evaluation tests carried out on the coated lens produced the following results:
1. Haze: less than 1%.
2. Dry adhesion: No peel-off has been observed after the “Crosshatch test”.
3. Adhesion after exposure to boiling water: No peel-off has been observed after the “Crosshatch test” made on the lens following its exposure to the boiling water.
4. Adhesion after exposure to OUV accelerated aging: No peel-off and no cracking has been observed after the “Crosshatch test” made on the lens following its exposure to the QUV tester.

### Example 1E

### Transparent Hardcoat Film Including Primer Layer

This example describes a two-layered acrylate based film, including a primer layer, which can be applied to CR39 lenses and which is producing a coating with an excellent Steel-Wool ratio and an interesting Bayer ratio.

### Preparation of the Mixture for the Formation of the Primer Layer

The procedure is the same as in the example 1D.

### Preparation of the Mixture for the Formation of the Hardening Layer

A mixture is made containing 68.4% of the centrifugated residue of the n-heptane washing of the product Nano G 103-31 from Clariant SFC (a dispersion in hexamethylene diacrylate of 30% of silicon dioxide colloidal particles with a methacrylate functionalized dispersant), 12.0% of a linear bifunctional acrylate monomer (polyethylene glycol diacrylate Mn 570, available from Sigma-Aldrich Co.), 1.7% of a radicalic photoinitiator (Irgacure 1000 from Ciba Specialty Chemicals), and 17.9% of ethanol.

Such mixture has a dilution ratio of solid content to solvent equal to 65% and it gives rise to a layer having a composition of about 47% of monomers, 50% of dispersed silicon dioxide particles, and 3% of polymerization initiators. The mixture is then shaken up to complete homogenization, and subsequently filtered across a polypropylene 0.4 micron filter.

### Preparation of the Extensible Transfer Film Assembly

With techniques similar to that already described in the preceding examples, the following operational sequence is run:
1. coating at 50° C. of the hardcoat layer on the “controlled” release silicone rubber support of the same type already described in example 1A, followed by drying at 80° C. for 2′, to a dry thickness of about 8 micron. The evaluation tests carried out on the sample layer prepared as described above, produced results close to those reported in example 1A.
2. coating at 50° C. of the primer layer on a temporary easy release support, followed by drying at 120° C. for 2′, to a dry thickness of about 5 micron. Said temporary easy release support can be formed by a sheet of silicone rubber made as the previous “controlled” release one, but without the superficial treatment with titanium IV butylate. As alternative, also a plain glass coated with a thin layer of silicone rubber can be used for the same purpose. The adhesion between primer layer and temporary easy release support, measured like the adhesion between hardening layer and extensible support in the IA example, was equal to about 7.2E3 Pa.
3. transfer by lamination at 50° C. of the primer layer on the hardcoat layer.

### Application of the Film and Evaluation of the Coated Substrate

The application procedure is similar to that shown in example 1A.

The evaluation tests carried out on the coated lens produced the following results:
1. Haze: less than 1%.
2. Dry adhesion: No peel-off has been observed after the “Crosshatch test”.
3. Adhesion after exposure to boiling water: No peel-off has been observed after the “Crosshatch test” made on the lens following its exposure to the boiling water.
4. Scratch resistance: 25 times that of the uncoated lens according to the “Steel Wool Test”.
5. Abrasion resistance: 2.2 times that of the uncoated lens according to the “Bayer Test”.

### Example 1F

### Transparent Hardcoat Film Including Primer Layer

This example describes a three-layered acrylate based film, including an adhesion layer, which can be applied to CR39 lenses and which is producing a coating with a good Steel-Wool ratio and an excellent Bayer ratio.

### Preparation of the Mixture for the Formation of the Primer Layer

The procedure is the same as in the example 1D.

### Preparation of the Mixture for the Formation of the First Hardening Layer

A mixture is made containing 45.4% of the centrifugated residue of the n-heptane washing of the product Nano G 103-31 from Clariant SFC, 25.2% of a linear bifunctional acrylate monomer (polyethylene glycol diacrylate Mn 700, available from Sigma-Aldrich Co.), 2.5% of an amine gelling agent (bis-hexamethylene-triamine, available from Sigma-Aldrich Co.), 1.3% of a radicalic photoinitiator (Irgacure 1000 from Ciba Specialty Chemicals), and 25.7% of ethanol.

Such mixture has a dilution ratio of solid content to solvent equal to 63% and it gives rise to a layer having a composition of about 58% of monomers, 36% of dispersed silicon dioxide particles, 4% of additives, and 2% of polymerization initiators. The mixture is then shaken up to complete homogenization, and subsequently filtered across a polypropylene 0.4 micron filter.

### Preparation of the Mixture for the Formation of the Second Hardening Layer

A mixture is made as the one described in example 1E for the hardening layer.

### Preparation of the Extensible Transfer Film Assembly

With extrusion techniques like pre-metered multilayer curtain coating or die-slot coating or slide coating (available from Troller Schweizer Engineering AG), the following operational sequence is run:
1. multilayer coating at 50° C. on the “easy release” support of the same type already described in example 1E and subsequent drying at 80° C. of the primer layer to a dry thickness of about 5 micron, followed by the first hardcoat layer to a dry thickness of about 20 micron, followed by the second hardcoat layer to a dry thickness of about 1 micron.
2. transfer by lamination at 50° C. of the previous tri-layer on the “controlled” release silicone rubber support of the same type already described in example 1A.

### Application of the Film and Evaluation of the Coated Substrate

The application procedure is similar to that shown in example 1A.

The evaluation tests carried out on the coated lens produced the following results:
1. Haze: less than 1%.
2. Dry adhesion: No peel-off has been observed after the “Crosshatch test”.
3. Adhesion after exposure to boiling water: No peel-off has been observed after the “Crosshatch test” made on the lens following its exposure to the boiling water.
4. Scratch resistance: 9.0 times that of the uncoated lens according to the “Steel Wool Test”.
5. Abrasion resistance: 4.0 times that of the uncoated lens according to the “Bayer Test”.

### Example 2

### Colored Hardcoat Film

Note: In the present example for simplicity the hardcoat layer is formed only with the materials and the processes described in the example 1A, but other examples could be of course also possible by using for instance the materials and processes described in the examples 1C, 1E, 1F, or still others.

### Preparation of the Mixture for the Formation of the Colored Hardening Layer

The procedure is similar to that shown in the example IA, with the exception of the addition to the mixture of approx 1% of a dye acrylated monomer (the “Disperse Red 1 acrylate” from Sigma-Aldrich was used, whose light absorption is maximum at a wavelength of 492 nm).

### Preparation of the Extensible Transfer Film Assembly, Application of the Film, and Evaluation of the Obtained Coated Lens

The procedure is similar to that shown in example 1A. The obtained results as well are similar, with the exception of the transmittance curve of the coated lens (measured by means of a spectrophotometer), which shows a reduction of the transmission in the blu-green wavelength range, which gives rise to a red color to the lens when observed in transmission.

To be noted that, in order to obtain other color hues (such as, for instance, green, yellow, blue, brown, grey) and/or other color intensities, it is enough to change only the dye (or a combination of dyes) and/or its dosage.

To be noted also that, whenever in the following examples the hardcoat is used only in its transparent version, it may be used as well, without any limitation, also in any of its colored versions.

### Example 3

### Transparent and Hydrophobic Hardcoat Film

Note: As for the example 2, in the present example for simplicity the hardcoat layer is formed only with the materials and the processes described in the example IA, but other examples could be of course also possible by using for instance the materials and processes described in the examples 1C, 1E, 1F, or still others.

### Preparation of the Mixture for the Formation of the Hardening Layer

The procedure is similar to that shown in example 1A.

### Preparation of the Mixture for the Formation of the Hydrophobic Layer

It is preliminarily synthesized, through conventional radical polymerization techniques, a linear random type copolymer of 20% molar of a fluoro-alkyl methacrylate monomer with low surface tension (Zonyl® TM from DuPont) and 80% molar of a methacrylate monomer with epoxy function for the final crosslinking (glycidyl-methacrylate, available from Sigma-Aldrich).

After the synthesis the copolymer is purified by precipitation with n-hexane.

Afterwards a mixture is prepared containing 0.282% of the preceding copolymer, 0.015% of a cationic photoinitiator (Irgacure 250 from Ciba Specialty Chemicals), 0.003% of a sensitizer for the photoinitiator (Irgacure ITX from Ciba Specialty Chemicals), and 99.7% of 2,2,2-trifluoroethanol.

Such mixture has a dilution ratio of the solid content in solvent equal to 0.3%, and gives rise to a layer with a composition of about 95% of fluorinated hardening resin (having a degree of polymerization/reticulation equal to 56%) and 5% of polymerization initiators.

The mixture is then shaken up to complete homogenization, and subsequently filtered across a polypropylene 0.4 micron filter.

### Preparation of the Extensible Transfer Film Assembly

With techniques similar to that already described in the preceding examples, the following operational sequence is run:
1. coating at 50° C. of the hydrophobic layer on the “controlled” release silicone rubber support of the same type already described in example 1A, followed by drying at 120° C. for 5′, to a dry thickness of about 20 nm
2. coating at 25° C. of the hardening layer on a temporary easy release support, followed by drying at 120° C. for 10′, to a dry thickness of about 8 micron. The adhesion between hardening layer and temporary easy release support was equal to about 6.8E3 Pa.
3. transfer by lamination at 120° C. of the hardening layer on the hydrophobic layer.

### Application of the Film and Evaluation of the Coated Substrate

The procedure is similar to that shown in example 1A. The obtained results as well are similar, with the exception of the hydrophobic property of the coated lens, which, markedly increases in comparison with the uncoated lens, being the water contact angle of the coated surface greater then 90° and the one of the uncoated surface about 50°.

### Hardcoat & Antireflection Films

Note: In the examples which follow, for simplicity all the low index layers (that is the hardcoat layer and the antireflection low index layer) are formed only with the materials and the processes described in the example 1A, but other examples could be of course also possible by using for instance the materials and processes described in the examples 1C, 1E, 1F, or still others.

### Example 4

### Transparent Narrow Band Antireflection Hardcoat Film

### Preparation of the Mixture for the Formation of the Hardening Layer

The procedure is the same as in the example 1A.

### Preparation of the Mixture for the Formation of the Low Refraction Index Layer

A mixture is prepared containing 1.57% of the above-mentioned product MIBK-ST from Nissan Chemical Co, 0.31% of the above-mentioned penta/esa-acrylate dipentaerythritol monomer, 0.16% of acrylic acid, 0.93% of the above-mentioned radicalic photoinitiator Irgacure 1000 from Ciba Specialty Chemicals, and 97.93% of 2,2,2-trifluoroethanol. Such a mixture has a dilution ratio of solid content to solvent equal to 1%, and it gives rise to a layer of the same composition already described in the lA example. The mixture is then shaken up to complete homogenization, and subsequently filtered across a polypropylene 0.4 micron filter.

### Preparation of the Mixture for the Formation of the Medium Refraction Index Layer

A mixture is prepared containing 1.74% of the product ZEOs from Buhler AG (a dispersion in ethanol of 46% of colloidal zirconium dioxide particles including dispersant), 0.14% of the above-mentioned penta/esa-acrylate dipentaerythritol monomer from sigma-Aldrich Co., 0.03% of the above-mentioned radicalic photoinitiator Irgacure 1000 from Ciba Specialty Chemicals, 0.02% of a fluorinated anionic surface-active agent (Fluorad FC-4430 from 3M Specialty Materials) and 98.07% of 2,2,2-trifluoroethanol. Such a mixture has a dilution ratio of solid content to solvent equal to 1% and it gives rise to a layer with a composition of about 15% of monomers, 80% of dispersed zirconium dioxide particles, 3% of polymerization initiators, and 2% of additives. The mixture is then shaken up to complete homogenization, and subsequently filtered across a polypropylene 0.4 micron filter.

### Preparation of the Extensible Transfer Film Assembly

With techniques similar to that already described in the preceding examples, the following operational sequence is run:
1. coating at 25° C. of the low index layer on the “controlled” release silicone support as described in the example 3, followed by drying at 120° C. for 10′, to a dry thickness of about 80 nm. The measured values for such layer of yield stress, maximum elongation, and adhesion to the “controlled” release support are similar to that obtained with the hardening layer in the lA example.
2. coating at 50° C. of the medium index layer on an “easy” release silicone support, followed by drying at the same temperature for 5′, to a dry thickness of about 95 nm. With such layer the measured value of yield stress is about 1.2E6 Pa, the one of maximum elongation is higher than 70%, and the one of the adhesion to the “easy” release silicone support is about 3.3E4 Pa.
3. coating at 25° C. of the hardening layer on an “easy” release silicone support, followed by drying at 120° C. for 10′, to a dry thickness of about 8 micron.
4. transfer by lamination at 25° C. of the medium index layer on the low index layer.
5. transfer by lamination at 25° C. of the hardening layer on the previously formed double layer.

### Application of the Film and Evaluation of the Coated Substrate

The procedure is similar to that shown in example 1A. The obtained results as well are similar, with the exception of reflectance of the coated lens, which markedly decreases in comparison with the uncoated lens, as shown by the reflectance curve (see FIG. 11a), which is of the “V-shaped” narrow band type.

To be noted that the uncoated lens shows a reflectance nearly constant at all the wavelengths and equal to about 4%.

### Example 5

### Transparent Hydrophobic Narrow Band Antireflection Hardcoat Film

### Preparation of the Mixture for the Formation of the Hardening Layer

The procedure is the same as in the example 1A.

### Preparation of the Mixtures for the Formation of the Low Refraction Index Layer and of the Medium Refraction Index Layer

The procedure is the same as in the example 4.

### Preparation of the Mixture for the Formation of the Hydrophobic Layer

The procedure is the same as in the example 3.

### Preparation of the Extensible Transfer Film Assembly

With techniques similar to that already described in the preceding examples, the following operational sequence is run:
1. coating at 50° C. of the hydrophobic layer on a “controlled” release silicone support, followed by drying at 120° C. for 5′, to a dry thickness of about 20 nm.
2. coating at 25° C. of the low index layer on an “easy” release silicone support, followed by drying at 120° C. for 10′, to a dry thickness of about 65 nm.
3. coating on “easy” release silicone supports of the medium index layer and of the hardening layer as described in the example 4, with the same dry thicknesses.
4. transfer by lamination at 120° C. of the low index layer on the hydrophobic layer.
5. transfer by lamination at 25° C. of the medium index layer on the previously formed double layer.
6. transfer by lamination at 25° C. of the hardening layer on the previously formed triple layer.

### Application of the Film and Evaluation of the Coated Substrate

The procedure is similar to that shown in example 1A. The obtained results are similar to that reported in example 4, with the exception of the hydrophobic propeity of the coated lens, which markedly increases in comparison with the uncoated lens (same results as the ones reported in example 3).

### Example 6

### Transparent Broad Band Antireflection Hardcoat Film

### Preparation of the Mixtures for the Formation of the Hardening Layer, of the Low Refraction Index Layer, and of the Medium Refraction Index Layer

The procedure is the same as in the example 4.

### Preparation of the Mixture for the Formation of the High Refractive Index Layer

A mixture is prepared containing 3.47% of the product Optolake from Catalysts & Chemicals Ind. Co. (a dispersion in ethanol of 23% of colloidal titanium dioxide particles including dispersant), 0.14% of the above-mentioned penta/esa-acrylate dipentaerythritol monomer from sigma-Aldrich Co., 0.03% of the above-mentioned radicalic photoinitiator Irgacure 1000 from Ciba Specialty Chemicals, 0.02% of the above-mentioned fluorinated anionic surface-active agent (Fluorad FC-4430 from 3M Specialty Materials) and 96.34% of 2,2,2-trifluoroethanol. Such a mixture has a dilution ratio of solid content to solvent equal to 1% and it gives rise to a layer with a composition of about 15% of monomers, 80% of dispersed titanium dioxide particles, 3% of polymerization initiators, and 2% of additives. The mixture is then shaken up to complete homogenization, and subsequently filtered across a polypropylene 0.4 micron filter.

### Preparation of the Extensible Transfer Film Assembly

The procedure is similar to that shown in example 4, with the only difference of interposing a phase of coating at 50° C. of a high index layer on an “easy” release silicone substrate followed by its transfer by lamination on the preceding low index layer. The dry thicknesses in this example are respectively 80 nm for the low index layer, 85 nm for the high index layer, 65 nm for the medium index layer, and 8 micron for the hardening layer. The measured values for the high index layer of yield stress, maximum elongation, and adhesion to the “easy” release silicone support are very close to the ones obtained with the medium index layer.

### Application of the Film and Evaluation of the Coated Substrate

The procedure is similar to that shown in example 1A.

The obtained results are similar to the ones reported in example 4, with the exception of reflectance curve of the coated lens, which performs much better showing a lower average reflection and being of the “W-shaped” broad band type (see FIG. 11b).

### Example 7

### Transparent Hydrophobic Broad Band Antireflection Hardcoat Film

### Preparation of the Mixtures and of the Extensible Transfer Film Assembly, Application of the Film, and Evaluation of the Coated Substrate

The procedure is similar to that shown in example 5, with the only difference of the addition of the high index layer, which is formed as already described in the example 6.

The obtained results are similar to that shown in example 5, with the only exception of the reflectance curve of the coated lens, which is similar to the one reported in example 6.

1-48. (canceled)

49. Use of an extensible transfer film for flat or curved surfaces, having at 25° C. a maximum elongation higher than 70%, and which is formed by layers whose composition is: (a) 15% to 99.5% in weight of polymerizable and/or cross-linkable monomers, (b) 0% to 60% in weight of resins, (c) 20% to 90% in weight of solid ultrafine particles, (d) 0% to 10% in weight of initiators and/or catalysts for polymerization and/or cross-linking, (e) 0% to 20% of additives, for coating lenses, screens or displays for watches and cellular phones.

50. Use according to claim 49, wherein said lenses are ophthalmic lenses.

51. Use of the extensible transfer film according to claim 49, wherein the film thickness is between 0.05 and 50 micron.

52. Use of the extensible transfer film according to claim 49, wherein said film comprises one or more layers capable to confer said surfaces one or more physical properties.

53. Use of the extensible transfer film according to claim 52, wherein said physical properties are chosen among scratch resistance, color, hydrophobic property and/or interferential properties.

54. Use of the extensible transfer film according to claim 52, wherein said physical property is an interferential property.

55. Use of the extensible transfer film according to claim 54, wherein said interferential property is antireflection.

56. Use of the extensible transfer film according to claim 49, wherein said film is transparent.

57. Use of the extensible transfer film according to claim 49, wherein said film is formed by layers whose composition is: (a) 15% to 99.5% in weight of polymerizable and/or cross-linkable monomers, (b) 0% to 60% in weight of resins, (c) 20% to 80% in weight of solid ultrafine particles, (d) 0% to 10% in weight of initiators and/or catalysts for polymerization and/or cross-linking, (e) 0% to 20% of additives.

58. Use of the extensible transfer film according to claim 49, wherein the monomers a) include one or more relatively rigid multifunctional monomers to provide a composition suitable to enhance the Steel Wool scratch resistance of the film after its final hardening.

59. Use of the extensible transfer film according to claim 49, wherein the monomers a) include one or more relatively flexible difunctional monomers to provide a composition suitable to enhance the Bayer abrasion resistance of the film after its final hardening.

60. Use of the extensible transfer film according to claim 59, wherein said flexible monomers are monomers having two functional groups joined by a relatively flexible long chain backbone.

61. Use of the extensible transfer film according to claim 49, wherein the monomers a) comprise monomers containing epoxy or oxetanic functional groups.

62. Use of the extensible transfer film according to claim 49, wherein the monomers a) comprise monomers containing ethylenically unsaturated functional groups.

63. Use of the extensible transfer film according to claim 62, wherein said ethylenically unsaturated functional groups are acrylate or methacrylate groups.

64. Use of the extensible transfer film according to claim 49, wherein the resins (b) have a degree of polymerization ranging from 50% to 100%.

65. Use of the extensible transfer film according to claim 64, wherein the resins (b) have a degree of polymerization ranging from 50% to 90%.

66. Use of the extensible transfer film according to claim 64, wherein the resins (b) are suitable also to enhance the yield stress of the layers forming the film before its final hardening.

67. Use of the extensible transfer film according to claim 49, wherein said solid ultrafine particles with the possible dispersing agents (c) have an average diameter between 0.005 micron and 0.05 micron.

68. Use of the extensible transfer film according to claim 49, wherein said solid ultrafine particles with the possible dispersing agents (c) are suitable also to enhance the yield stress of the layers forming the film before its final hardening.

69. Use of the extensible transfer film according to claim 49, wherein said solid ultrafine particles with the possible dispersing agents (c) are suitable also to enhance the Steel Wool scratch resistance of the film after its final hardening.

70. Use of the extensible transfer film according to claim 49, wherein said additives (e) are chosen among releasing agents, tackifiers, gelling agents, UV stabilizers, UV absorbers, antioxidants, surface active agents, colorants and adhesion promoters.

71. Use of the extensible transfer film according to claim 49, wherein the components (a), (b), (c), (d) and (e) form 100% in weigh of the film.

72. Use of the extensible transfer film according to claims 49, wherein said layer suitable to produce scratch resistance has a thickness between 0.5 micron and 50 micron, preferably between 2 micron and 10 micron.

73. Use of the extensible transfer film according to claims 49, wherein said layers suitable to produce interferential properties have a thickness between 0.005 micron and 0.2 micron.

74. Use of the extensible transfer film according to claims 49, wherein said layer suitable to produce hydrophobic properties has a thickness between 0.005 micron and 0.1 micron.

75. Use of the extensible transfer film according to claim 49, wherein said layers comprise a primer layer suitable to increase the adhesion of the film to the substrate after the final hardening of the film.

76. Use of the extensible transfer film according to claim 75, wherein said primer layer has a thickness between 0.001 micron and 20 micron.

77. Use of the extensible transfer film according to claim 76, wherein said primer layer has a thickness between 0.1 micron and 10 micron.

78. Use of the extensible transfer film according to claim 49, wherein said film has a maximum elongation higher than 100% at 25° C.

79. An extensible transfer film assembly comprising an extensible transfer film according to claim 49, an extensible support and, optionally, one or more protective liners.

80. The extensible transfer film assembly according to claim 49, wherein said extensible support has a thickness between 10 micron and 5000 micron.

81. The extensible transfer film assembly according to claim 80, wherein said extensible support has a thickness between 30 micron and 1000 micron.

82. The extensible transfer film assembly according to claim 49, wherein said extensible support is essentially made of cellulose derivatives, polyesters, polycarbonates, polyamides, polyolefins and/or silicone rubbers, with or without superficial treatment with repellent polymeric materials.

83. The extensible transfer film assembly according to claim 49, wherein said protective liners have a thickness between 10 micron and 500 micron.

84. The extensible transfer film assembly according to claim 49, wherein said protective liners have a thickness between 30 micron and 100 micron.

85. The extensible transfer film assembly according to claim 49, wherein said protective liners are essentially made of polymeric materials, repellent or electrostatic, or polymeric or paper materials coated with repellent polymeric material.

86. The extensible transfer film assembly according to claim 49, wherein the adhesion between the possible protective liners and respectively the extensible support and/or the extensible transfer film, is lower than the adhesion between the extensible transfer film and the extensible support, the adhesion between the adjoining layers forming the extensible transfer film, and the yield stress of said layers.

87. The extensible transfer film assembly according to claim 86, wherein the adhesion between the extensible transfer film and the extensible support is lower than both that between the adjoining layers forming the extensible transfer film and the yield stress of said layers.

88. A lens, screen or display for watches and cellular phones coated with the extensible transfer film according to claim 49.

89. A lens according to claim 88, which is an ophthalmic lens.
